(19) United States
(12) Patent Application Publication
(10) Pub. No.: US 2025/0346501 A1
(43) Pub. Date: Nov. 13, 2025

(54) SYSTEMS, ARTICLES, AND METHODS RELATED TO FOAM FRACTIONATION OF FLUIDS

(71) Applicant: Gradiant Corporation, Woburn, MA (US)

(72) Inventors: Hui Han, Singapore (SG); Yang Chen, Singapore (SG); Jonita Chew Hui Ting, Singapore (SG); Hui Wen Neo, Singapore (SG); Steven Lam, Singapore (SG); Ming Feng Tay, Singapore (SG)

(73) Assignee: Gradiant Corporation, Woburn, MA (US)

(21) Appl. No.: 19/203,609

(22) Filed: May 9, 2025

Related U.S. Application Data
(60) Provisional application No. 63/645,780, filed on May 10, 2024.

(51) Int. Cl. C02F 1/24; B01F 23/231; B01F 23/235; B01F 101/00; C02F 101/36

(52) U.S. Cl. CPC C02F 1/24; B01F 23/23121; B01F 23/235; B01F 2101/305; C02F 2101/36; C02F 2301/046

(57) ABSTRACT

Certain aspects of the present disclosure are related to systems and methods related to the removal of PFAS molecules. In one aspect, systems comprising a foam fractionation system are generally described. In some embodiments, the foam fractionation system comprises a vessel and/or a bubbler. The vessel, in accordance with certain embodiments, comprises an elongated portion and a body portion comprising a main body portion and a taper portion. The bubbler is configured to receive a gas input and inject bubbles into an interior volume of the vessel. An input liquid solution comprising one or more per- and/or polyfluoroalkyl substance (PFAS) molecules and a surfactant enters the foam fractionation system. The input liquid solution is treated by the foam fractionation system such that some or all of the PFAS molecules are separated into a foamate output. In some embodiments, a liquid output exiting the foam fractionation system comprises a relatively low amount, if any, of the PFAS molecules. In some embodiments, the liquid output and/or the foamate output is recycled (e.g., after one or more passes through one or more foam fractionation system).

### RELATED APPLICATIONS

This application claims priority under 35 U.S.C. § 119 (e) to U.S. Provisional Patent Application No. 63/645,780, filed May 10, 2024, and entitled “Systems, Articles, and Methods Related to Foam Fractionation of Fluids,” which is incorporated herein by reference in its entirety for all purposes.

### TECHNICAL FIELD

Systems, articles, and methods related to foam fractionation of fluids are generally described.

### BACKGROUND

Per- and/or polyfluoroalkyl substances (PFAS) pose health and environmental problems. Therefore, improved methods and related systems for treating PFAS-containing mixtures are desirable.

### SUMMARY

Systems, articles, and methods related to foam fractionation of fluids are generally described. The subject matter of the present disclosure involves, in some cases, interrelated products, alternative solutions to a particular problem, and/or a plurality of different uses of one or more systems and/or articles.

In one aspect, methods for treating a solution comprising one or more per- and/or polyfluoroalkyl substance (PFAS) molecules are described.

In some embodiments, the method comprises exposing an aqueous solution comprising one or more PFAS molecules and a surfactant to bubbles such that at least some of the PFAS molecules are associated with at least some of the bubbles, thereby forming PFAS-associated bubbles, wherein at least 80% of the total volume of the bubbles is made up of bubbles having a largest cross-sectional dimension of greater than or equal to 1 micron and less than or equal to 200 microns; separating at least some of the PFAS-associated bubbles from a remainder of the aqueous solution, thereby forming: a foamate comprising the at least some of the PFAS-associated bubbles, and a liquid output comprising at least a portion of the remainder of the aqueous solution, the liquid output having a concentration of PFAS molecules that is less than that of the aqueous solution.

In some embodiments, the method comprises exposing an aqueous solution comprising one or more PFAS molecules and a surfactant to bubbles such that at least some of the PFAS molecules are associated with at least some of the bubbles, thereby forming PFAS-associated bubbles; separating at least some of the PFAS-associated bubbles from a remainder of the aqueous solution, thereby forming: a foamate comprising the at least some of the PFAS-associated bubbles, wherein the foamate comprises the one or more PFAS molecules at a concentration that is greater than that of the aqueous solution by a factor of greater than or equal to 50, and a liquid output comprising at least a portion of the remainder of the aqueous solution, the liquid output having a concentration of PFAS molecules that is less than that of the aqueous solution.

In another aspect, foam fractionation systems are described.

In some embodiments, the foam fractionation system comprises a vessel comprising: a vessel body portion comprising an interior volume configured to process an input liquid solution; an elongated portion in fluid communication with the interior volume; and a bubbler configured to: receive a gas input, and inject bubbles into the interior volume; wherein: at least 80% of the total volume of the bubbles is made up of bubbles having a largest cross-sectional dimension of greater than or equal to 1 micron and less than or equal to 200 microns; and the elongated portion has: a flowpath length along a long axis along a direction of fluid flow from the interior volume; and an average cross-sectional area along the long axis; wherein a ratio of the flowpath length divided by the average cross-sectional area is greater than or equal to 1 cm/cm².

In some embodiments, the foam fractionation system comprises a vessel comprising: a vessel body portion comprising an interior volume configured to process an input liquid solution; an elongated portion in fluid communication with the interior volume; and a bubbler configured to: receive a gas input, and inject bubbles into the interior volume; wherein: at least 80% of the total volume of the bubbles is made up of bubbles having a largest cross-sectional dimension of greater than or equal to 1 micron and less than or equal to 200 microns; and the elongated portion has an average cross-sectional area perpendicular to a direction of fluid flow from the interior volume, and a ratio of the volume of the interior volume divided by the average cross-sectional area of the elongated portion is greater than or equal to 2000 cm.

In some embodiments, the foam fractionation system comprises a vessel comprising: a vessel body portion comprising an interior volume configured to process an input liquid solution; an elongated portion in fluid communication with the interior volume; and a bubbler configured to: receive a gas input, and inject bubbles into the interior volume; wherein: at least 80% of the total volume of the bubbles is made up of bubbles having a largest cross-sectional dimension of greater than or equal to 1 micron and less than or equal to 200 microns; and the vessel body portion comprises a main body portion and a taper portion, wherein the main body portion is connected to the elongated portion via the taper portion.

In some embodiments, the foam fractionation system comprises a vessel comprising: a vessel body portion comprising an interior volume configured to process an input liquid solution; an elongated portion comprising a foamate output at a distal end of the elongated portion with respect to the interior volume, the foamate output in fluid communication with the interior volume; a liquid solution entry in fluid communication with the interior volume; a liquid output in fluid communication with the interior volume; and a bubbler configured to: receive a gas input, and inject bubbles into the interior volume; wherein: at least 80% of the total volume of the bubbles is made up of bubbles having a largest cross-sectional dimension of greater than or equal to 1 micron and less than or equal to 200 microns; and the elongated portion has: a flowpath length along a long axis along a direction of fluid flow from the interior volume to the foamate output; and an average cross-sectional area along the long axis; wherein a ratio of the flowpath length divided by the average cross-sectional area is greater than or equal to 1 cm/cm².

In some embodiments, the foam fractionation system comprises a vessel comprising: a vessel body portion comprising an interior volume configured to process an input liquid solution; an elongated portion comprising a foamate output at a distal end of the elongated portion with respect to the interior volume, the foamate output in fluid communication with the interior volume; a liquid solution entry in fluid communication with the interior volume; a liquid output in fluid communication with the interior volume; and a bubbler configured to: receive a gas input, and inject bubbles into the interior volume; wherein: at least 80% of the total volume of the bubbles is made up of bubbles having a largest cross-sectional dimension of greater than or equal to 1 micron and less than or equal to 200 microns; and the elongated portion has an average cross-sectional area perpendicular to a direction of fluid flow from the interior volume to the foamate output, and a ratio of the volume of the interior volume divided by the average cross-sectional area of the elongated portion is greater than or equal to 2000 cm.

In some embodiments, the foam fractionation system comprises a vessel comprising: a vessel body portion comprising an interior volume configured to process an input liquid solution; an elongated portion comprising a foamate output at a distal end of the elongated portion with respect to the interior volume, the foamate output in fluid communication with the interior volume; a liquid solution entry in fluid communication with the interior volume; a liquid output in fluid communication with the interior volume; and a bubbler configured to: receive a gas input, and inject bubbles into the interior volume; wherein: at least 80% of the total volume of the bubbles is made up of bubbles having a largest cross-sectional dimension of greater than or equal to 1 micron and less than or equal to 200 microns; and the vessel body portion comprises a main body portion and a taper portion, wherein the main body portion is connected to the elongated portion via the taper portion.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A is a schematic diagram depicting a foam fractionation system, according to some embodiments.

FIG. 1B is a schematic diagram depicting an elongated portion of a vessel, according to some embodiments.

FIG. 1C is a schematic diagram depicting a cross-section of an elongated portion of a vessel, according to some embodiments.

FIG. 1D is a schematic diagram depicting an elongated portion of a vessel including a long axis and a short axis, according to some embodiments.

FIG. 1E is a schematic diagram depicting a foam fractionation system that is configured to recycle a liquid output, according to some embodiments.

FIG. 1F is a schematic diagram depicting a foam fractionation system that is configured to recycle a foamate output, according to some embodiments.

FIG. 1G is a schematic diagram depicting an elongated portion of a foam fractionation system, the elongated portion comprising a liquid drainage channel, according to some embodiments.

FIG. 2A is a schematic diagram depicting a multi-stage foam fractionation system wherein each foam fractionation system is fluidically connected via a liquid output, according to some embodiments.

FIG. 2B is a schematic diagram depicting a multi-stage foam fractionation system wherein each foam fractionation system is fluidically connected via a liquid output and wherein a liquid output is recycled, according to some embodiments.

FIG. 2C is a schematic diagram depicting a multi-stage foam fractionation system wherein each foam fractionation system is fluidically connected via a foamate output, according to some embodiments.

FIG. 2D is a schematic diagram depicting a multi-stage foam fractionation system wherein each foam fractionation system is fluidically connected via a foamate output and

wherein a foamate output is recycled, according to some embodiments.

FIG. 2E is a schematic diagram depicting a multi-stage foam fractionation system wherein each foam fractionation system is fluidically connected via a foamate output and wherein a first foamate output is recycled in a batch manner, according to some embodiments.

FIG. 2F is a schematic diagram depicting a multi-stage foam fractionation system wherein each foam fractionation system is fluidically connected via a foamate output and wherein a third foamate output is recycled in a continuous manner, according to some embodiments.

FIG. 3A is a schematic diagram depicting a PFAS destruction system fluidically connected to a foam fractionation system, according to some embodiments.

FIG. 3B is a schematic diagram depicting a PFAS destruction system fluidically connected to a foam fractionation system wherein a PFAS destruction output is recycled back into the foam fractionation system, according to some embodiments.

FIG. 4A is a schematic diagram depicting a protein skimmer fluidically connected to a foam fractionation system, according to some embodiments.

FIG. 4B is a schematic diagram depicting a protein skimmer fluidically connected to a foam fractionation system that is fluidically connected to a PFAS destruction system, according to some embodiments.

### DETAILED DESCRIPTION

Certain aspects of the present disclosure are related to systems and methods for the removal of PFAS molecules. In one aspect, systems comprising a foam fractionation system are described. In some embodiments, the foam fractionation system comprises a vessel and/or a bubbler. The vessel, in accordance with certain embodiments, comprises an elongated portion and a body portion comprising a main body portion and a taper portion. In certain embodiments, the bubbler is configured to receive a gas input and inject bubbles into an interior volume of the vessel. In certain embodiments, an input liquid solution comprising one or more per- and/or polyfluoroalkyl substance (PFAS) molecules and a surfactant enters the foam fractionation system. In accordance with certain embodiments, the input liquid solution is treated by the foam fractionation system such that some or all of the PFAS molecules are separated into a foamate output. In some embodiments, a liquid output exiting the foam fractionation system comprises a relatively low amount, if any, of the PFAS molecules.

PFAS molecules are known to have contaminated portions of the environment, including water sources for agricultural applications, industrial applications, and consumption. PFAS molecules are generally challenging to remove from liquid sources (e.g., water sources) especially PFAS molecules having relatively short alkyl chains. Conventional protein skimmers may be used to concentrate PFAS molecules in a solution (e.g., an aqueous solution and/or a foam). However, to obtain a solution having a relatively high concentration of PFAS molecules sufficient for typical destruction processes, multiple protein skimming processes are needed. The use of multiple skimming processes can result in high operational expenditure and capital expenditure. Relatively large amounts of area and equipment are needed to carry out multiple protein skimming processes. Accordingly, systems and methods capable of concentrating PFAS molecules are needed. Foam fractionation processes, used in lieu of or in conjunction with one or more skimming processes, may facilitate the removal of the PFAS molecules from a liquid by concentrating the PFAS molecules in a foam prior to destruction.

The systems and the methods described in the present disclosure involve, in accordance with certain embodiments, a foam fractionation system. The foam fractionation system, in some embodiments, facilitates the separation of one or more PFAS molecules from a liquid solution (e.g., an aqueous solution). In some embodiments, the foam fractionation system introduces bubbles having a relatively small size (e.g., microbubbles) into the liquid solution such that PFAS molecules associate with at least some of the bubbles. In some embodiments, the foam fractionation system is capable of concentrating the PFAS molecules in the input liquid solution by an advantageous factor. The foam fractionation system may be capable of replacing one or more protein skimmers used in typical processes while achieving higher concentration factors, potentially reducing the overall cost and footprint of PFAS concentration processes.

For purposes of clarity, “PFAS” will be used herein to refer to per- and/or polyfluoroalkyl substances. PFAS may include one or more perfluoroalkyl substances without any polyfluoroalkyl substances, one or more polyfluoroalkyl substances without any perfluoroalkyl substances, or one or more perfluoroalkyl substances and one or more polyfluoroalkyl substances.

Various elements described in this disclosure are said to be in fluidic communication with each other. As used herein, two elements are in fluidic communication with each other (or, equivalently, in fluid communication with each other) when fluid may be transported from one of the elements to the other of the elements without otherwise altering the configurations of the elements or a configuration of an element between them (such as a valve). Two conduits connected by an open valve (thus allowing for the flow of fluid between the two conduits) are considered to be in fluidic communication with each other. In contrast, two conduits separated by a closed valve (thus preventing the flow of fluid between the conduits) are not considered to be in fluidic communication with each other.

Various elements described in this disclosure are said to be fluidically connected to each other. As used herein, two elements are fluidically connected to each other when they are connected such that, under at least one configuration of the elements and any intervening elements, the two elements are in fluidic communication with each other. Two foam fractionation systems connected by a valve and conduits that permit flow between the foam fractionation systems in at least one configuration of the valve would be said to be fluidically connected to each other. To further illustrate, two foam fractionation systems that are connected by a valve and conduits that permit flow between the foam fractionation systems in a first valve configuration but not a second valve configuration are considered to be fluidically connected to each other both when the valve is in the first configuration and when the valve is in the second configuration. In contrast, two foam fractionation systems that are not connected to each other (e.g., by a valve, another conduit, or another component) in a way that would permit fluid to be transported between them under any configuration would not be said to be fluidically connected to each other. Elements that are in fluidic communication with each other are always fluidically connected to each other, but not all elements that are fluidically connected to each other are necessarily in fluidic communication with each other.

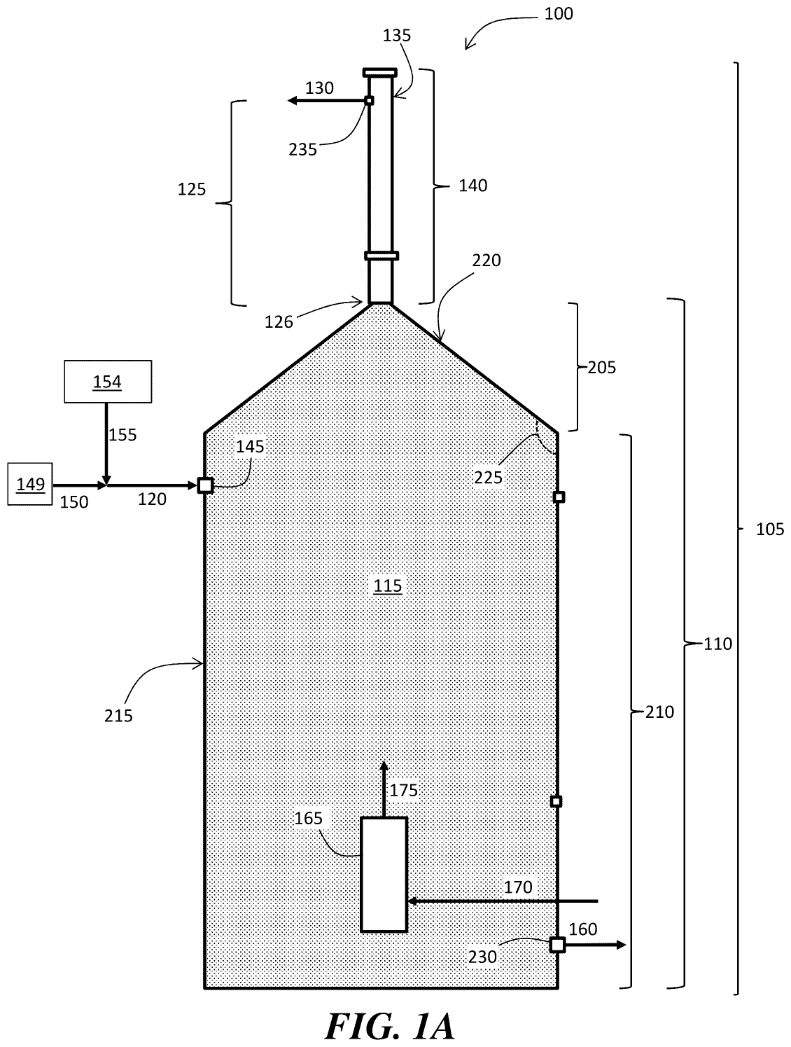

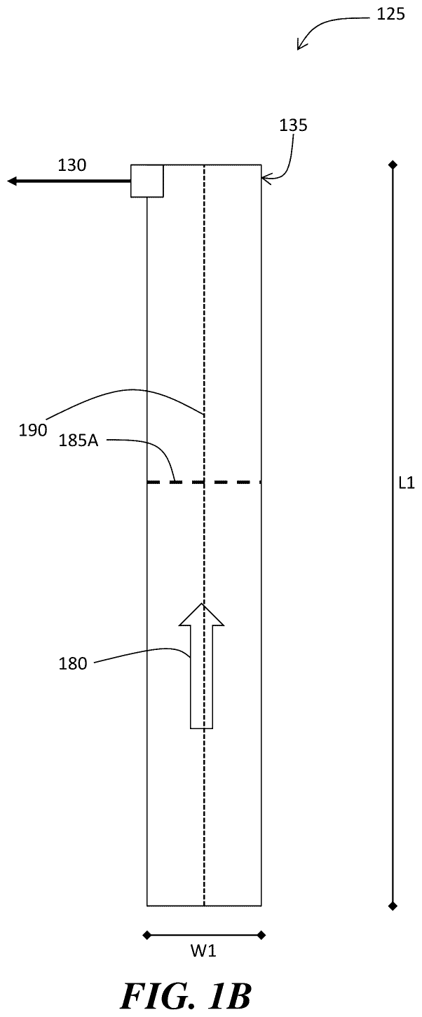

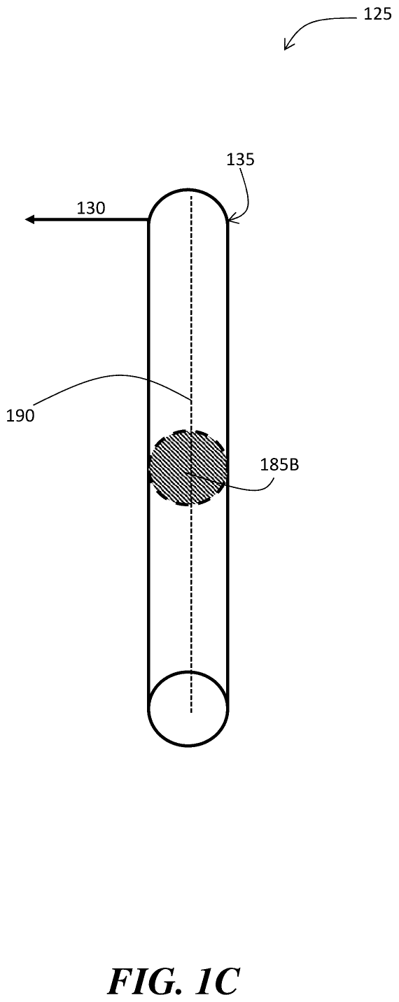

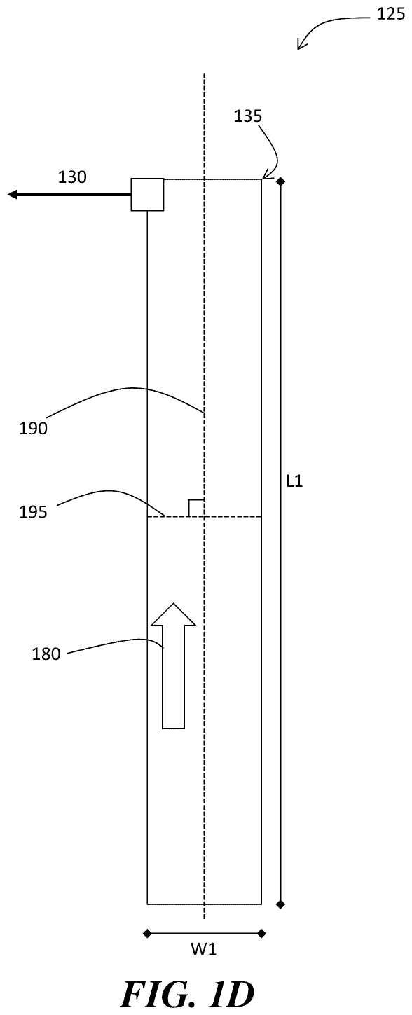

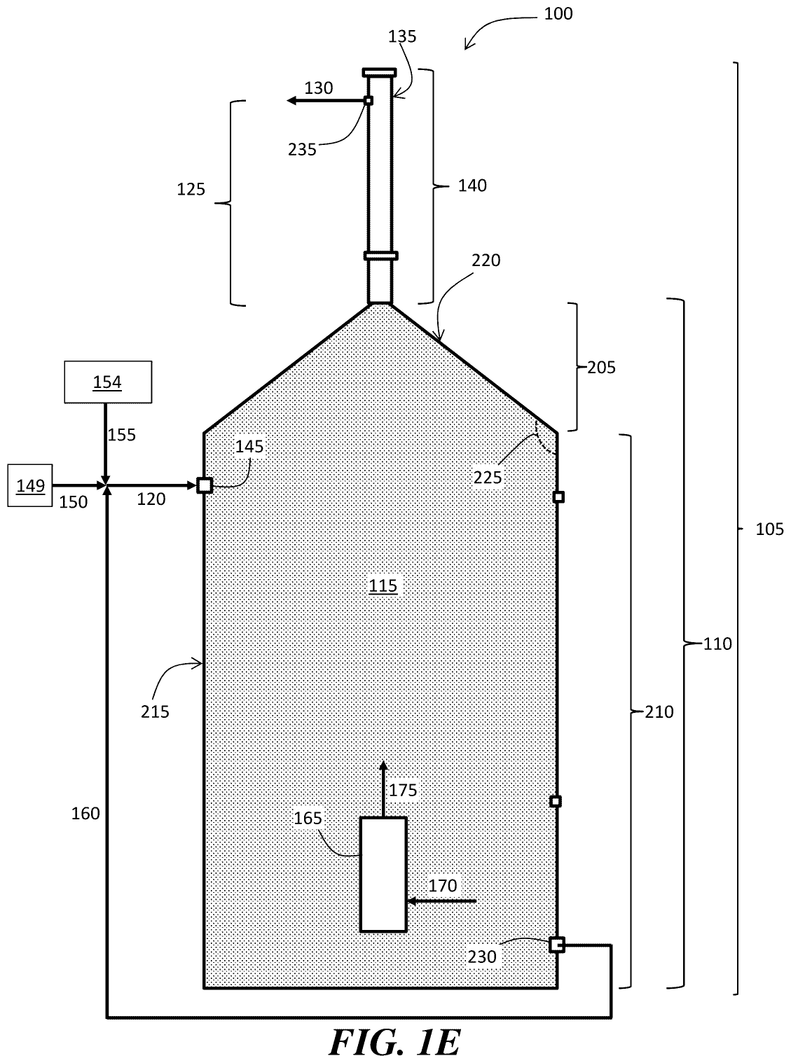

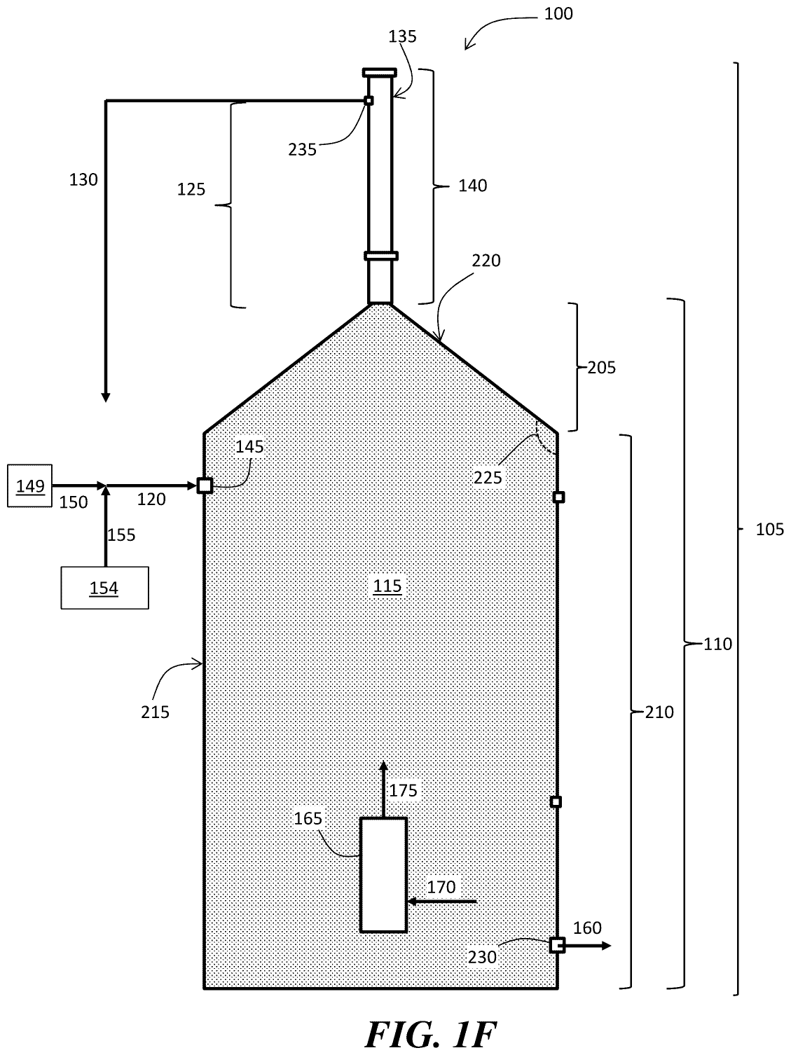

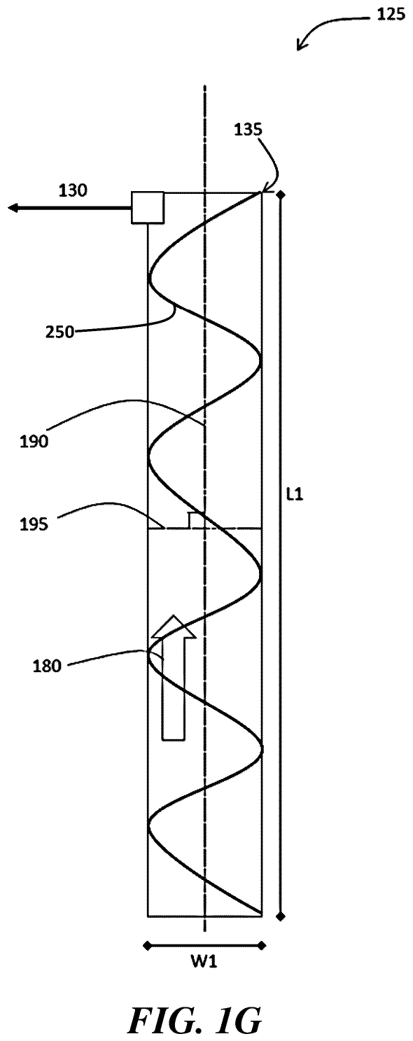

In some embodiments, the foam fractionation system comprises a vessel. For example, as shown in FIG. 1A, foam fractionation system 100 comprises vessel 105. The vessel, in accordance with certain embodiments, is configured to hold a liquid solution such that the solution may be treated by the foam fractionation system. The vessel comprises, in some embodiments, a vessel body portion comprising an interior volume configured to hold at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of an input liquid solution. For example, as shown in FIG. 1A, foam fractionation system 100 comprises vessel 105 comprising vessel body portion 110. Vessel body portion 110 comprises interior volume 115 (shaded) configured to hold all of input liquid solution 120.

In some embodiments, the vessel comprises an elongated portion. In some embodiments, the elongated portion is part of a larger elongated structure, while in other cases, the elongated portion is the entirety of an elongated structure. For example, as shown in FIG. 1A, vessel 105 comprises elongated structure 140 comprising elongated portion 125. The elongated portion extends from the output of the vessel body portion (e.g., the output of the taper portion in embodiments in which a taper portion is present) to the foamate output of the elongated portion. For example, as shown in FIG. 1A, elongated portion 125 extends from an output of taper portion 205 (at arrow 126) to outlet 235. In some embodiments, two or more outlets are positioned on the elongated portion. In such embodiments, the elongated portion extends from the output of the taper portion to the outlet on the elongated portion that is furthest away from the output of the taper portion in a direction parallel to the elongated portion. For example, as shown in FIGS. 1A-1B, elongated portion 125 extends from an output of taper portion 205 to outlet 235 where outlet 235 on elongated portion 125 is an outlet on elongated portion 125 that is furthest away from output of taper portion 205 along direction L1. In some embodiments, the elongated portion comprises a foamate output at a distal end of the elongated portion with respect to the interior volume. For example, as shown in FIG. 1A, elongated portion 125 comprises foamate output 130 at distal end 135 of elongated portion 125 with respect to interior volume 115. In some embodiments, the foamate output exits the distal end of the elongated portion of the vessel via one or more outlets. For example, as shown in FIG. 1A, foamate output 130 exits distal end 135 of elongated portion 125 of vessel 105 via outlet 235. In embodiments in which the elongated portion has multiple outlets, multiple elongated portions (which can spatially overlap with each other) can be present. In certain embodiments, it can be advantageous to use a system in which a single elongated portion is present. It should be understood that any portion of the elongated structure that extends beyond the foamate output is not considered as being part of the elongated portion. In some embodiments, the elongated portion extends along at least 25%, at least 50%, at least 75%, at least 99%, or 100% of the total length of the elongated structure. While in some embodiments, the distal end of the elongated portion is in a different position than the distal end of the elongated structure (e.g., when the foamate output is not located at the distal end of the elongated structure), in certain embodiments, the distal end of the elongated portion and the distal end of the elongated structure are in the same position (e.g., when there is no portion of the elongated structure extending beyond the foamate output). In some embodiments, a force (e.g., a negative pressure such as a vacuum) may be applied to facilitate the foamate output to exit the elongated portion.

In some embodiments, the foamate output is in fluidic communication with the interior volume. For example, as shown in FIG. 1A, foamate output 130 is in fluidic communication with interior volume 115.

In some embodiments, the vessel comprises a liquid solution entry. For example, as shown in FIG. 1A, vessel 105 comprises liquid solution entry 145. In some embodiments, the liquid solution entry is in fluidic communication with the interior volume. For example, as shown in FIG. 1A, liquid solution entry 145 is in fluidic communication with interior volume 115. In some embodiments, the liquid solution entry is fluidically connected to a source of surfactant. For example, as shown in FIG. 1A, liquid solution entry 145 is fluidically connected to source 149 of surfactant 150. In some embodiments, the liquid solution entry is fluidically connected to a source of aqueous input solution comprising one or more PFAS molecules. For example, as shown in FIG. 1A, liquid solution entry 145 is fluidically connected to source 154 of aqueous input solution 155 comprising one or more PFAS molecules. The liquid solution entry can, in accordance with certain embodiments, be configured to receive the input liquid solution. For example, as shown in FIG. 1A, liquid solution entry 145 is configured to receive input liquid solution 120. In some embodiments, the liquid solution entry comprises one or more inlets fluidically connected to the interior volume of the vessel.

In some embodiments, the input liquid solution comprises PFAS molecules and/or surfactant. In some embodiments, the input liquid solution comprises at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the aqueous input solution comprising the one or more PFAS molecules. For example, in FIG. 1A, input liquid solution 120 comprises all of aqueous input solution 155. In some embodiments, the input liquid solution comprises at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the surfactant stream. For example, as shown in FIG. 1A, input liquid solution 120 comprises all of surfactant stream 150.

In some embodiments, the vessel comprises a liquid output. In some embodiments, the liquid output is in fluidic communication with the interior volume of the foam fractionation system. For example, as shown in FIG. 1A, vessel 105 comprises liquid output 160 that is in fluidic communication with interior volume 115. In some embodiments, the liquid output comprises at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, and/or up to 99 wt %, up to 99.9 wt %, or more) of the input liquid solution that enters the vessel. For example, as shown in FIG. 1A, liquid output 160 comprises a portion of input liquid solution 120 that enters vessel 105. In some embodiments, the liquid output exits the vessel via one or more outlets. For example, as shown in FIG. 1A, liquid output 160 exits vessel 105 via outlet 230. In some embodiments, the liquid output comprises a relatively low amount of the PFAS molecules and/or the surfactant. In some embodiments, the liquid output comprises an advantageously low amount of the surfactant. In some embodiments, the concentration of the surfactant in the liquid output is less than or equal to 5 mg/L. In some embodiments, the concentration of the surfactant in the liquid output is less than or equal to 2 mg/L (e.g., less than or equal to 1.5 mg/L, less than or equal to 1 mg/L, less than or equal to 0.75 mg/L, less than or equal to 0.5 mg/L, and/or greater than or equal to 0.01 mg/L, greater than or equal to 0.05 mg/L, or greater than or equal to 0.1 mg/L). In some embodiments, the concentration of the surfactant in the liquid output is less than or equal to 100 μg/L. In some embodiments, the concentration of the surfactant in the liquid output is less than or equal to 1 μg/L. In some embodiments, the concentration of the surfactant in the liquid output is less than or equal to 30% (or less than or equal to 25%, less than or equal to 20%, less than or equal to 15%, less than or equal to 10%, or less) of the concentration of the surfactant in the aqueous input solution on a mass basis.

In some embodiments, the foam fractionation system comprises a bubbler. In some embodiments, the bubbler is configured to receive a gas input and inject bubbles into the interior volume. For example, as shown in FIG. 1A, foam fractionation system 100 comprises bubbler 165. Bubbler 165 is configured to receive gas input 170 and inject bubbles 175 into interior volume 115. In some embodiments, at least a portion of the bubbler is located within the interior volume of the foam fractionation system such that the bubbles are injected directly into fluid within the interior volume, when present. For example, as shown in FIG. 1A, all of bubbler 165 is located within interior volume 115 such that bubbles 175 are injected directly into fluid within interior volume 115. In some embodiments, the bubbler is at least partially submerged in liquid in the interior volume of the vessel such that the bubble can be injected directly into the liquid. The bubbles may be formed by supplying gas to via one or more inlets on the bubbler.

In some embodiments, the gas input has a relatively low flow rate. In some embodiments, the gas input has a gas flow rate of less than or equal to 1 L/min (e.g., less than or equal to 0.8 L/min, less than or equal to 0.5 L/min, less than or equal to 0.3 L/min, and/or greater than or equal to 0.1 L/min or greater than or equal to 0.2 L/min). In some embodiments, the gas input has a gas flow rate of less than or equal to 50 L/min (e.g., less than or equal to 40 L/min, less than or equal to 30 L/min, less than or equal to 20 L/min, less than or equal to 10 L/min, less than or equal to 5 L/min, less than or equal to 1 L/min, less than or equal to 0.8 L/min, less than or equal to 0.5 L/min, less than or equal to 0.3 L/min, and/or greater than or equal to 0.1 L/min or greater than or equal to 0.2 L/min). It has been observed in the context of this disclosure that in some instances use of a relatively low gas flow rate contributes to relatively high extent of concentration of PFAS in the foamate. It is believed that in some instances, such a flow rate reduces or prevents over-foaming in the foam fractionation system that could reduce separation effectiveness.

In some embodiments, the gas input has a flow rate that is related to (and in some instances dependent on) the volume of the interior volume of the foam fractionation system. For example, as shown in FIG. 1A, the flow rate of gas input 170 is dependent on the volume of interior volume 115, in accordance with some embodiments. In some embodiments, the gas input has a gas flow rate of less than or equal to 50 L/min per m³ of interior volume, less than or equal to 40 L/min per m³ of interior volume, less than or equal to 30 L/min per m³ of interior volume, less than or equal to 20 L/min per m³ of interior volume, less than or equal to 10 L/min per m³ of interior volume, less than or equal to 5 L/min per m³ of interior volume, less than or equal to 1 L/min per m³ of interior volume, less than or equal to 0.8 L/min per m³ of interior volume, less than or equal to 0.5 L/min per m³ of interior volume, less than or equal to 0.3 L/min per m³ of interior volume, and/or greater than or equal to 0.1 L/min per m³ of interior volume, greater than or equal to 0.05 L/min per m³ of interior volume, or greater than or equal to 0.01 L/min per m³ of interior volume. Combinations of these ranges are possible. Such flow rates may be applicable to batch and/or continuous processing of the liquid input solution.

In some embodiments, the gas input has a flow rate that is related to (and in some instances dependent on) the average cross-sectional area of the elongated portion of the foam fractionation system. For example, as shown in FIG. 1A, the flow rate of gas input 170 can be dependent on the average cross-sectional area of elongated portion 125. In some embodiments, the gas input has a flow rate of greater than or equal to 50 L/min per m² of the average cross-sectional area of the elongated portion, greater than or equal to 60 L/min per m² of the average cross-sectional area of the elongated portion, greater than or equal to 70 L/min per m² of the average cross-sectional area of the elongated portion, greater than or equal to 80 L/min per m² of the average cross-sectional area of the elongated portion, greater than or equal to 90 L/min per m² of the average cross-sectional area of the elongated portion, greater than or equal to 100 L/min per m² of the average cross-sectional area of the elongated portion, and/or less than or equal to 1000 L/min per m² of the average cross-sectional area of the elongated portion, less than or equal to 950 L/min per m² of the average cross-sectional area of the elongated portion, less than or equal to 900 L/min per m² of the average cross-sectional area of the elongated portion, or less. Combinations of these ranges are possible. In some embodiments, flow rates of less than or equal to 50 L/min per m² of the average cross-sectional area of the elongated portion may not be sufficient to transport foamate through the elongated portion such that the foamate exits the foam fractionation system via the foamate output.

In some embodiments, the ratio of the volume of the interior volume of the vessel body portion divided by the average cross-sectional area of an elongated portion is relatively high. For example, referring to FIG. 1A, in some embodiments, the ratio of the volume of interior volume 115 divided by the average cross-sectional area of elongated portion 125 is relatively high.

The average cross-sectional area of an elongated portion is the number average of all cross-sectional areas of the internal volume of that elongated portion, taken along the long axis of that elongated portion. Each cross-sectional area along the long axis of the elongated portion is taken across a plane that is perpendicular to the long axis of the elongated portion. Moreover, each cross-sectional area includes only the interior volume of the elongated portion (so, for example, the cross-sectional area of an 8-inch pipe with a 1-inch wall thickness, thus having an inner cylindrical volume having a radius of 3 inches, would be 9π inches²). To illustrate, as shown in FIG. 1B, elongated portion 125 has, perpendicular to direction of arrow 180 (which is parallel to both the long axis of the elongated portion and the direction of fluid flow through the elongated portion), a cross-sectional area indicated by cross-section 185A. A perspective view of the cross-section 185A is shown in FIG. 1C. To determine the average cross-sectional area, one would determine the area of the cross-section at each location along the long axis of the elongated portion and average those values. Referring to FIGS. 1B-1C, for example, the average cross-sectional area of elongated portion 125 may be determined by taking multiple cross-sections, similar to cross-section 185A, along length L1 of elongated portion 125, summing the cross-sectional areas of each cross-section, and dividing the sum by the number of cross-sections taken to obtain the average cross-sectional area. For a cylinder, as shown in FIGS. 1B and 1C, the average cross-sectional area of the elongated region would simply be the cross-sectional area of any one of the cross-sectional circles along the long axis of the elongated region, since all individual cross-sectional areas of a cylinder are the same. For elongated regions with cross-sections varying in size along the long axis of the elongated region, multiple measurements would need to be taken and an average value calculated.

The interior volume of the vessel body portion includes the interior volume of the main body portion of the vessel and the interior volume of the taper portion of the vessel, but it does not include the interior volume of the elongated portion of the vessel.

In some embodiments, the ratio of the volume of the interior volume of the vessel body portion divided by the average cross-sectional area of the elongated portion is greater than or equal to 2000 cm (e.g., greater than or equal to 3000 cm; greater than or equal to 4000 cm; greater than or equal to 5000 cm; greater than or equal to 7500 cm; greater than or equal to 10,000 cm; and/or up to 50,000 cm; up to 75,000 cm; up to 100,000 cm; or more). In some embodiments, the ratio of the volume of the interior volume of the vessel body portion divided by the average cross-sectional area of the elongated portion defined by the outlet of the elongated structure through which the most volume of fluid flows during operation of the system is greater than or equal to 2000 cm (e.g., greater than or equal to 3000 cm; greater than or equal to 4000 cm; greater than or equal to 5000 cm; greater than or equal to 7500 cm; greater than or equal to 10,000 cm; and/or up to 50,000 cm; up to 75,000 cm; up to 100,000 cm; or more). In some embodiments, the ratio of the volume of the interior volume of the vessel body portion divided by the average cross-sectional area of the elongated portion defined by the outlet of the elongated structure that is closest to the vessel body portion (as measured by flow path through the elongated structure) is greater than or equal to 2000 cm (e.g., greater than or equal to 3000 cm; greater than or equal to 4000 cm; greater than or equal to 5000 cm; greater than or equal to 7500 cm; greater than or equal to 10,000 cm; and/or up to 50,000 cm; up to 75,000 cm; up to 100,000 cm; or more). In some embodiments, the ratio of the volume of the interior volume of the vessel body portion divided by the average cross-sectional area of the elongated portion defined by the outlet of the elongated structure that is farthest from the vessel body portion (as measured by flow path through the elongated structure) is greater than or equal to 2000 cm (e.g., greater than or equal to 3000 cm; greater than or equal to 4000 cm; greater than or equal to 5000 cm; greater than or equal to 7500 cm; greater than or equal to 10,000 cm; and/or up to 50,000 cm; up to 75,000 cm; up to 100,000 cm; or more).

In some embodiments, the ratio between the flowpath length of the elongated portion and the average cross-sectional area of the elongated portion in a plane perpendicular to the long axis of the elongated portion is relatively high. In some embodiments, the elongated portion has a flowpath length along a long axis along a direction of fluid flow from the interior volume to the foamate output. For example, as shown in FIG. 1D, elongated portion 125 has flowpath length L1 along long axis 190 along direction of fluid flow 180 from interior volume 115 (not shown) to foamate output 130. In some embodiments, the elongated portion has an average cross-sectional area. For example, as shown in FIG. 1C, elongated portion 125 has cross-sectional area 185B in a plane perpendicular to long axis 190. To determine the average cross-sectional area of the elongated portion, the cross-sectional areas along the long axis of the elongated portion are averaged (in this context, number-averaged). For example, as shown in FIG. 1B, cross-section 185A can repeated along long axis 190 of elongated portion 125, such that the corresponding cross-sectional areas (for example, see cross-sectional area 185B in FIG. 1C corresponding to cross-section 185A) are number-averaged to obtain the average cross-sectional area of elongated portion 125. In some embodiments, the elongated portion has an average cross-sectional area and/or a length that is configured to allow foamate to flow along the elongated portion. In some embodiments, the ratio between the flowpath length of the elongated portion and the average cross-sectional area of the elongated portion is at least partially dependent on the force of which gas flows along the elongated portion. The gas (e.g., gas within microbubbles of the foamate) may need to overcome gravitational force exerted on the foamate for the foamate to move upwards from the taper portion to the outlet on the elongated portion. In some embodiments, the elongated portion may have a relatively small average cross-sectional area and a relatively large length. In some embodiments, the ability of the foamate to flow along the elongated portion can be at least partially dependent on the concentration of the foamate (e.g., the ratio of gas to liquid in the foamate). In some cases, the foamate has a relatively low gas to liquid ratio, and in some such cases, the elongated portion may have a higher ratio between the flowpath length and the average cross-sectional area of the elongated portion compared to cases where the foamate comprises a relatively high gas to liquid ratio. In some embodiments, the length of the elongated portion is at least partially dependent on the volume of the vessel. For instance, the elongated portion may have a length that is different when fluidically connected to a vessel having a large volume than the length of the elongation portion fluidically connected to a vessel having a small volume.

In some embodiments, the average cross-sectional area of the elongated portion is less than or equal to 20 cm² (e.g., less than or equal to 18 cm², less than or equal to 15 cm², less than or equal to 12 cm², less than or equal to 10 cm² and/or greater than or equal to 0.007 cm² or greater than or equal to 0.03 cm²). In some embodiments, the average cross-sectional area of the elongated portion defined by the outlet of the elongated structure through which the most volume of fluid flows during operation of the system is less than or equal to 20 cm² (e.g., less than or equal to 18 cm², less than or equal to 15 cm², less than or equal to 12 cm², less than or equal to 10 cm² and/or greater than or equal to 0.007 cm² or greater than or equal to 0.03 cm²). In some embodiments, the average cross-sectional area of the elongated portion defined by the outlet of the elongated structure that is closest to the vessel body portion (as measured by flow path through the elongated structure) is less than or equal to 20 cm² (e.g., less than or equal to 18 cm², less than or equal to 15 cm², less than or equal to 12 cm², less than or equal to 10 cm² and/or greater than or equal to 0.007 cm² or greater than or equal to 0.03 cm²). In some embodiments, the average cross-sectional area of the elongated portion defined by the outlet of the elongated structure that is farthest from the vessel body portion (as measured by flow path through the elongated structure) is less than or equal to 20 cm² (e.g., less than or equal to 18 cm², less than or equal to 15 cm², less than or equal to 12 cm², less than or equal to 10 cm² and/or greater than or equal to 0.007 cm² or greater than or equal to 0.03 cm²).

In some embodiments, the average cross-sectional area of the elongated portion is related to the desired gas flow rate to be used in the foam fractionation system. In some embodiments, the average cross-sectional area of the elongated portion is less than or equal to 65 cm² per 1 L/min (or less than or equal to 60 cm² per 1 L/min, less than or equal to 55 cm² per 1 L/min, less than or equal to 50 cm² per 1 L/min, less than or equal to 45 cm² per 1 L/min, less than or equal to 40 cm² per 1 L/min, or less).

In some embodiments, the elongated portion has a ratio of the flowpath length divided by the average cross-sectional area of the elongated portion that is greater than or equal to 1 cm/cm² (e.g., greater than or equal to 100 cm/cm², greater than or equal to 1000 cm/cm², greater than or equal to 10000 cm/cm², greater than or equal to 100000 cm/cm², and/or less than or equal to 1400000 cm/cm², less than or equal to 1450000 cm/cm², or less than or equal to 1500000 cm/cm²). In some embodiments, the elongated portion defined by the outlet of the elongated structure through which the most volume of fluid flows during operation of the system has a ratio of the flowpath length divided by the average cross-sectional area of the elongated portion that is greater than or equal to 1 cm/cm² (e.g., greater than or equal to 100 cm/cm², greater than or equal to 1000 cm/cm², greater than or equal to 10000 cm/cm², greater than or equal to 100000 cm/cm², and/or less than or equal to 1400000 cm/cm², less than or equal to 1450000 cm/cm², or less than or equal to 1500000 cm/cm²). In some embodiments, the elongated portion defined by the outlet of the elongated structure that is closest to the vessel body portion (as measured by flow path through the elongated structure) has a ratio of the flowpath length divided by the average cross-sectional area of the elongated portion that is greater than or equal to 1 cm/cm² (e.g., greater than or equal to 100 cm/cm², greater than or equal to 1000 cm/cm², greater than or equal to 10000 cm/cm², greater than or equal to 100000 cm/cm², and/or less than or equal to 1400000 cm/cm², less than or equal to 1450000 cm/cm², or less than or equal to 1500000 cm/cm²). In some embodiments, the elongated portion defined by the outlet of the elongated structure that is farthest from the vessel body portion (as measured by flow path through the elongated structure) has a ratio of the flowpath length divided by the average cross-sectional area of the elongated portion that is greater than or equal to 1 cm/cm² (e.g., greater than or equal to 100 cm/cm², greater than or equal to 1000 cm/cm², greater than or equal to 10000 cm/cm², greater than or equal to 100000 cm/cm², and/or less than or equal to 1400000 cm/cm², less than or equal to 1450000 cm/cm², or less than or equal to 1500000 cm/cm²).

In some embodiments, the elongated portion has a relatively large flowpath length. The flowpath length of the elongated portion generally refers to the length along the long axis of the elongated portion from the input to the elongated portion to the output from the elongated portion. Accordingly, the flowpath length is measured along the direction of fluid flow from interior volume to the foamate output. For example, as shown in FIG. 1D, elongated portion 125 has flowpath length L1 along long axis 190, which is along direction of fluid flow 180 from interior volume 115 (not shown) to foamate output 130.

In some embodiments, the flow path length of the elongated portion is greater than or equal to 20 cm (or greater than or equal to 30 cm; greater than or equal to 40 cm; greater than or equal to 75 cm; greater than or equal to 100 cm; greater than or equal to 150 cm; greater than or equal to 200 cm; greater than or equal to 500 cm; greater than or equal to 1000 cm; and/or up to 8000 cm; up to 9000 cm; up to 10,000 cm; or more). In some embodiments, the flow path length of the elongated portion defined by the outlet of the elongated structure through which the most volume of fluid flows during operation of the system is greater than or equal to 20 cm (or greater than or equal to 30 cm; greater than or equal to 40 cm; greater than or equal to 75 cm; greater than or equal to 100 cm; greater than or equal to 150 cm; greater than or equal to 200 cm; greater than or equal to 500 cm; greater than or equal to 1000 cm; and/or up to 8000 cm; up to 9000 cm; up to 10,000 cm; or more). In some embodiments, the flow path length of the elongated portion defined by the outlet of the elongated structure that is closest to the vessel body portion (as measured by flow path through the elongated structure) is greater than or equal to 20 cm (or greater than or equal to 30 cm; greater than or equal to 40 cm; greater than or equal to 75 cm; greater than or equal to 100 cm; greater than or equal to 150 cm; greater than or equal to 200 cm; greater than or equal to 500 cm; greater than or equal to 1000 cm; and/or up to 8000 cm; up to 9000 cm; up to 10,000 cm; or more). In some embodiments, the flow path length of the elongated portion defined by the outlet of the elongated structure that is farthest from the vessel body portion (as measured by flow path through the elongated structure) is greater than or equal to 20 cm (or greater than or equal to 30 cm; greater than or equal to 40 cm; greater than or equal to 75 cm; greater than or equal to 100 cm; greater than or equal to 150 cm; greater than or equal to 200 cm; greater than or equal to 500 cm; greater than or equal to 1000 cm; and/or up to 8000 cm; up to 9000 cm; up to 10,000 cm; or more).

In some embodiments, the elongated portion comprises one or more liquid drainage channels. Liquid drainage channels may be configured to collect and/or transport liquid from the foamate in the elongated portion to the interior volume of the foam fractionation system. In some embodiments, instead of relying solely on drainage from the foam's liquid channel or node, these additional channels provide extra surface area to enhance liquid (e.g., water) drainage. The channels' structures may comprise fibers, belts, and/or a three-dimensional structure (e.g., a mesh). For example, as shown in FIG. 1G, elongated portion 125 is shown comprising liquid drainage channel 250. Liquid drainage channel 250 is positioned along elongated portion 125 such that liquid (e.g., water) may drain from elongated portion 125 to interior volume 115 (not shown). In some embodiments, the liquid drainage channel is an engineered liquid drainage structure. In some such embodiments, the engineered liquid drainage structure includes hydrophilic surface materials. Such hydrophilic surface channels may contribute to enhanced water affinity.

In some embodiments, the vessel body portion comprises a main body portion and a taper body portion. For example, as shown in FIG. 1A, foam fractionation system 100 comprises vessel 105 comprising vessel body portion 110, and vessel body portion 110 comprises main body portion 210 and taper portion 205. The taper portion is not necessarily required in all embodiments, and in some embodiments, the main body portion is connected to the elongated portion directly (e.g., with no intervening components such as a taper portion). In other embodiments, the main body portion is connected to the elongated portion indirectly, for example, via a taper portion. For example, as shown in FIG. 1A, main body portion 210 is connected to elongated portion 125 via taper portion 205.

In some embodiments, the main body portion comprises a body wall at least partially enclosing the interior volume. For example, as shown in FIG. 1A, main body portion 210 comprises body wall 215 that partially encloses interior volume 115.

In some embodiments, the taper portion comprises a taper wall. For example, as shown in FIG. 1A, taper portion 205 comprises taper wall 220. The taper wall can also at least partially enclose the interior volume of the vessel body portion.

In some embodiments, an angle established by the body wall and the taper wall facing the interior volume of the body portion of the vessel is greater than or equal to 120 degrees (or greater than or equal to 120.1 degrees, greater than or equal to 120.5 degrees, greater than or equal to 121 degrees, greater than or equal to 122 degrees, and/or greater than or equal to 125 degrees). In some embodiments, an angle established by the body wall and the taper wall facing the interior volume of the body portion of the vessel is less than or equal to 150 degrees (or less than or equal to 149.9 degrees, less than or equal to 149 degrees, or less than or equal to 148 degrees). Combinations of these ranges are also possible (e.g., greater than or equal to 120 degrees and less than or equal to 150 degrees). For example, as shown in FIG. 1A, angle 225 established by body wall 215 and taper wall 220 facing interior volume 115 is greater than or equal to 120 degrees and less than or equal to 150 degrees.

In some embodiments, the bubbles exiting the bubbler may have a relatively small size. For example, as shown in FIG. 1A, bubbler 165 injects bubbles 175 having a relatively small size into interior volume 115. In some embodiments, at least 80% (or at least 82.5%, at least 85%, at least 87.5%, at least 90% and/or up to 99%, up to 99.9%, up to 99.99%, or more (e.g., all)) of the total volume of the bubbles is made up of bubbles having a largest cross-sectional dimension of greater than or equal to 1 micron (or greater than or equal to 2 microns, greater than or equal to 5 microns, greater than or equal to 10 microns, or greater than or equal to 15 microns). In some embodiments, at least 80% (or at least 82.5%, at least 85%, at least 87.5%, at least 90% and/or up to 99%, up to 99.9%, up to 99.99%, or more (e.g., all)) of the total volume of the bubbles is made up of bubbles having a largest cross-sectional dimension of less than or equal to 200 microns (or less than or equal to 199 microns, less than or equal to 195 microns, or less than or equal to 190 microns). Combinations of these ranges are also possible.

In some embodiments, relatively small bubbles may allow for at least some (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the bubbles to associate with at least some (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the PFAS molecules thereby forming PFAS-associated bubbles. The PFAS-associated bubbles can, in some embodiments, then rise to the surface of the liquid, when present, in the interior volume of the vessel thereby separating the PFAS molecules from the rest of the liquid. Relatively small bubble size (e.g., bubbles having largest cross-sectional dimensions that are relative small), in some embodiments, can allow for greater surface area on the bubbles that the PFAS molecules and/or surfactant may associate with. Relatively small bubbles also rise to the surface in a relatively slow manner, in some embodiments, allowing for a relatively large residence time compared to bubbles having a relatively large size. In some embodiments, the PFAS molecules have sufficient time to associate with the bubbles that have a relatively large residence time.

In some embodiments, the relatively small size of the bubbles allows for a relatively high degree of interaction between the bubbles and the surfactant and/or PFAS such that a relatively large amount of PFAS molecules associate with the bubbles. Without wishing to be bound by any particular theory, relatively small bubbles (e.g., bubbles having a largest cross-sectional dimension that is relatively small) may be sufficiently small to separate a hydrophobic portion and a hydrophilic portion of the surfactant (e.g., a hydrophobic tail of the surfactant and/or a hydrophilic head of the surfactant). In some embodiments, the ratio between the average largest cross-sectional dimension of the bubbles and the effective hydrodynamic radius of the surfactant is less than or equal to 10,000 (or less than or equal to 9500, less than or equal to 9000, less than or equal to 8000, less than or equal to 7000 and/or greater than or equal to 45, greater than or equal to 50, or greater than or equal to 55). The effective hydrodynamic radius of the surfactant can be determined using the Stokes-Einstein formula as described in Equation 1:

$$D = \frac{{k}_{b} T}{6 πη {R}_{H}} \qquad Equation 1$$

where D is the diffusion coefficient of the surfactant in the solvent, kb is the Boltzmann constant, T is the temperature, n is the solvent's dynamic viscosity, and Ru is the effective hydrodynamic radius of the surfactant. In some embodiments, relatively small bubbles (e.g., bubbles having a largest cross-section dimension less than or equal to 200 microns) are capable of capturing surfactant molecules more readily than relatively large bubbles.

In some embodiments, little to no colloidal gas aphrons are formed during operation of the system and methods of this disclosure. For example, in some instances no colloidal gas aphrons are formed or, if any colloidal gas aphrons are formed, the total volume of the colloidal gas aphrons are less than 1%, less than 0.01%, less than 0.001%, less than 0.0001%, or less of the total volume of bubbles produced.

In some embodiments, a method for treating a solution comprising one or more per- and/or polyfluoroalkyl substance (PFAS) molecules is described. In some embodiments, treating the solution comprises exposing an aqueous solution comprising one or more PFAS molecules and a surfactant to bubbles such that at least some (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the PFAS molecules are associated with at least some (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the bubbles. In some embodiments, the foam fractionation system is configured to expose the aqueous solution to bubbles such that at least some of the PFAS molecules are associated with at least some of the bubbles. For example, as shown in FIG. 1A, foam fractionation system 100 is configured to expose liquid solution 120 (e.g., the aqueous solution) comprising all of aqueous input solution 155, comprising one or more PFAS molecules, and all of source 149 of surfactant 150 to bubbles 175 injected by bubbler 165 into interior volume 115. In some embodiments, the aqueous solution is exposed to bubbles thereby forming PFAS-associated bubbles.

In some embodiments, treating the solution comprises separating at least some of the PFAS-associated bubbles from a remainder of the aqueous solution. In some embodiments, at least some (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the PFAS-associated bubbles are separated from the remainder of the aqueous solution thereby forming a foamate, comprising the at least some (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the PFAS-associated bubbles, and a liquid output comprising at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the remainder of the aqueous solution. In some embodiments, the foam fractionation separator is configured to perform the separation. For example, as shown in FIG. 1A, foam fractionation system 100 is configured to separate at least some of the PFAS-associated bubbles from the remainder of the aqueous solution thereby forming foamate output 130 and liquid output 160. In some embodiments, the foamate comprises the at least some of the PFAS-associated bubbles. In some embodiments, the PFAS-associated bubbles are PFAS-associated microbubbles.

In some embodiments, the foamate comprises a relatively high concentration of the PFAS molecules. In some embodiments, the foamate comprises a concentration of the PFAS molecules that is higher than the concentration of the PFAS molecules in the aqueous input solution and/or the liquid output. For example, as shown in FIG. 1A, the concentration of the PFAS molecules in foamate output 130 can be higher than the concentration of the PFAS molecules in aqueous input solution 155 and/or liquid output 160. In some embodiments, the foamate comprises PFAS molecules at a concentration that is higher than the concentration of the PFAS molecules in the aqueous solution by a factor of greater than or equal to 50 (or greater than or equal to 55; greater than or equal to 60; greater than or equal to 80; greater than or equal to 100; greater than or equal to 150; greater than or equal to 200; and/or up to 80,000; up to 90,000; up to 100,000; or more). In some embodiments, the foamate comprises PFAS molecules at a concentration that is higher than the concentration of the PFAS molecules in the liquid output by a factor of greater than or equal to 50 (or greater than or equal to 55; greater than or equal to 60; greater than or equal to 80; greater than or equal to 100; greater than or equal to 150; greater than or equal to 200; and/or up to 80,000; up to 90,000; up to 100,000; or more).

As used herein, when a second quantity is greater than a first quantity by a factor of X, then the magnitude of the second quantity is X times the first quantity. For example, if the first quantity is 5 and the second quantity is 100, then the second quantity is greater than the first quantity by a factor of 20 (because 5 times 20 is 100). Also as used herein, when a first quantity is less than a second quantity by a factor of X, then the magnitude of the second quantity is X times the first quantity. In the example above, the first quantity would be said to be less than the second quantity by a factor of 20 (again, because 5 times 20 is 100).

In some embodiments, a ratio of the concentration of the one or more PFAS molecules in the foamate to the concentration of the one or more PFAS molecules in the aqueous solution is relatively high. For example, as shown in FIG. 1A, the ratio of the concentration of the PFAS molecules in foamate output 130 to the concentration of the one or more PFAS molecules in aqueous input solution 155 is relatively high. In some embodiments, the ratio of the concentration of the one or more PFAS molecules in the foamate to the concentration of the one or more PFAS molecules in the aqueous solution is greater than or equal to 50 (or greater than or equal to 55; greater than or equal to 75; greater than or equal to 100; greater than or equal to 125; greater than or equal to 150; greater than or equal to 200; and/or up to 8,000; up to 8,500; up to 9,000, up to 10,000; or more).

In some embodiments, the foamate output from the system (e.g., via foamate output 130) comprises a relatively large portion of the PFAS molecules input into the system (e.g., via input liquid solution 120). For example, in some embodiments, the foamate output from the system comprises at least 60 wt %, at least 70 wt %, at least 80 wt %, at least 90 wt %, at least 99 wt %, or 100 wt % of the PFAS molecules input into the system.

In some embodiments, the liquid output comprises at least a portion (e.g., at least 60 wt %, at least 70 wt %, at least 80 wt %, at least 90 wt %, at least 99 wt %, or 100 wt %) of the remainder of the aqueous solution. For example, as shown in FIG. 1A, liquid output 160 comprises at least a portion of the remainder of aqueous input solution 155.

In some embodiments, the liquid output from the system (e.g., via one or more liquid output streams) comprises a relatively large amount of the water from the aqueous input solution. For example, in some embodiments, the liquid output from the system (e.g., via one or more liquid output streams) comprises at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt % of the water from the aqueous input solution. In some embodiments, liquid output from the system (e.g., via one or more liquid output streams) comprises a relatively large amount of the portion of the aqueous input solution that is not PFAS molecules. For example, in some embodiments, the liquid output from the system (e.g., via one or more liquid output streams) comprises at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt % of the portion of the aqueous input solution that is not PFAS molecules.

In some embodiments, the liquid output has a concentration of PFAS molecules that is relatively low compared to the concentration of the PFAS molecules in the aqueous solution. In some embodiments, the liquid output has a concentration of PFAS molecules that is less (by a factor of at least 2; at least 5; at least 10; at least 20; at least 50; at least 100; or at least 1000; and/or up to 80,000; up to 90,000; or up to 100,000) than the concentration of the one or more PFAS molecules in the aqueous solution. For example, in some embodiments, liquid output 160 has a concentration of the one or more PFAS molecules that is less than the concentration of the one or more PFAS molecules in aqueous input solution 155, for example, by any of the factors above.

In some embodiments, the liquid output has a concentration of the PFAS molecules that is relatively low. In some embodiments, the liquid output has a concentration of the PFAS molecules that less than or equal to 10 μg/L, less than or equal to 5 μg/L, less than or equal to 1 μg/L, less than or equal to 0.75 μg/L, less than or equal to 0.5 μg/L, less than or equal to 0.25 μg/L, less than or equal to 0.1 μg/L, less than or equal to 0.005 μg/L, less than or equal to 0.1 μg/L 0.002 μg/L, less than or equal to 0.001 μg/L, or 0 μg/L.

In some embodiments, the treating of the solution is performed using any of the system described herein. For example, as shown in FIG. 1A, foam fractionation system 100 is configured to treat input liquid solution 120 such that all of input liquid solution 120 is exposed to bubbles 175 such that PFAS-associated bubbles are separated from a remainder of aqueous input solution 155 to form foamate output 130 while the remainder of aqueous input solution 155 forms liquid output 160.

In some embodiments, the liquid output is recycled such that the liquid output undergoes further treatment by the foam fractionation system. In some embodiments, the input liquid solution comprises at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the liquid output. For example, FIG. 1E is substantially the same as FIG. 1A except that liquid output 160 exiting foam fractionation system 100 is recycled back into foam fractionation system 100 such that input liquid solution 120 comprises all of liquid output 160. In some embodiments, the liquid output retains some amount of the one or more PFAS molecules, and by recycling the liquid output back through the foam fractionation system for additional treatment, remaining PFAS molecules in the liquid output may be separated into the foamate output. It should be understood that, while the above description relates to the recycling of the liquid output, any of the outputs of the foam fractionation systems described herein (e.g., the liquid output and/or the foamate output) can be recycled. In some embodiments, the foamate output is recycled such that the input liquid solution comprises at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the foamate output. For example, FIG. 1F is substantially the same as FIG. 1A except that foamate output 130 exiting foam fractionation system 100 is recycled back into foam fractionation system 100 such that input liquid solution 120 comprises all of foamate output 130. Such a recycling may be performed, for example, after a batch operation of foam fractionation system 100.

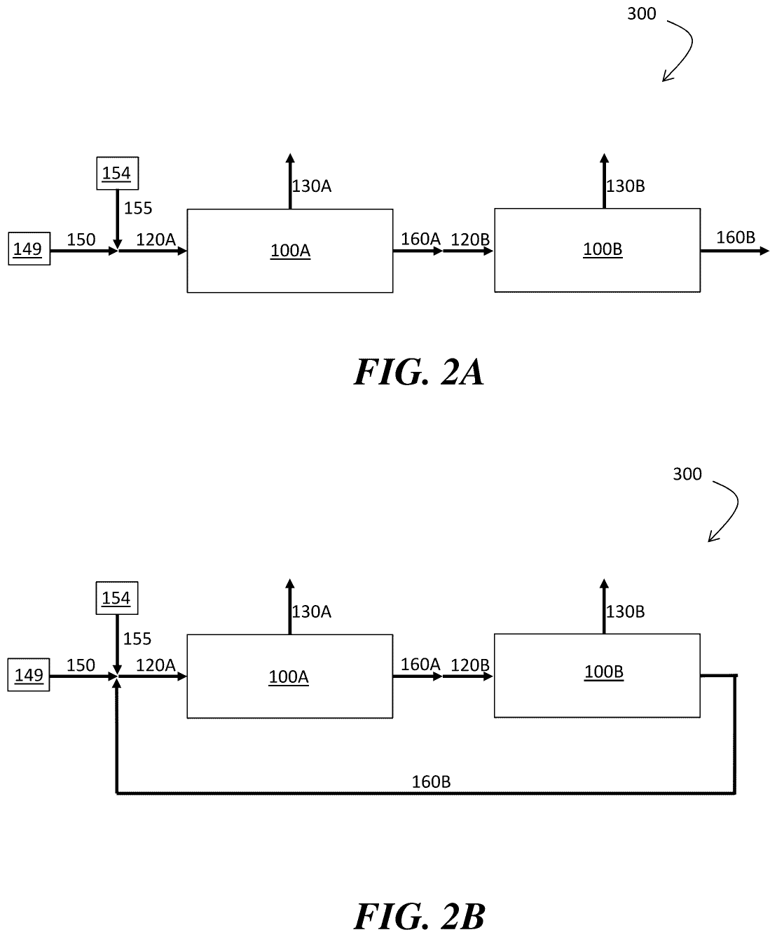

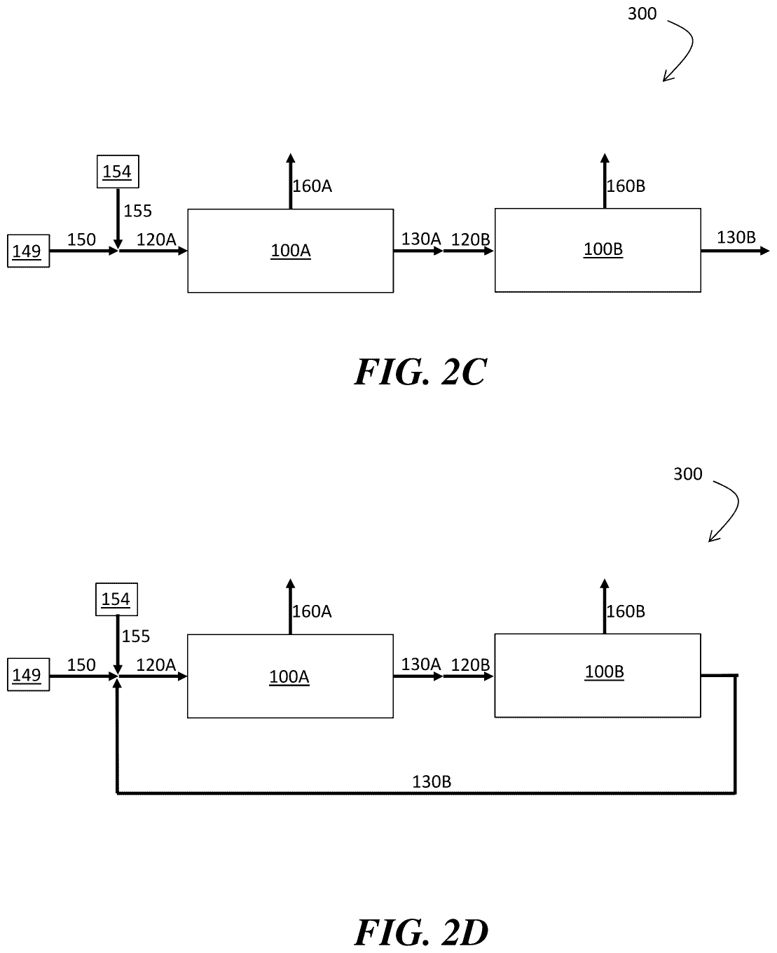

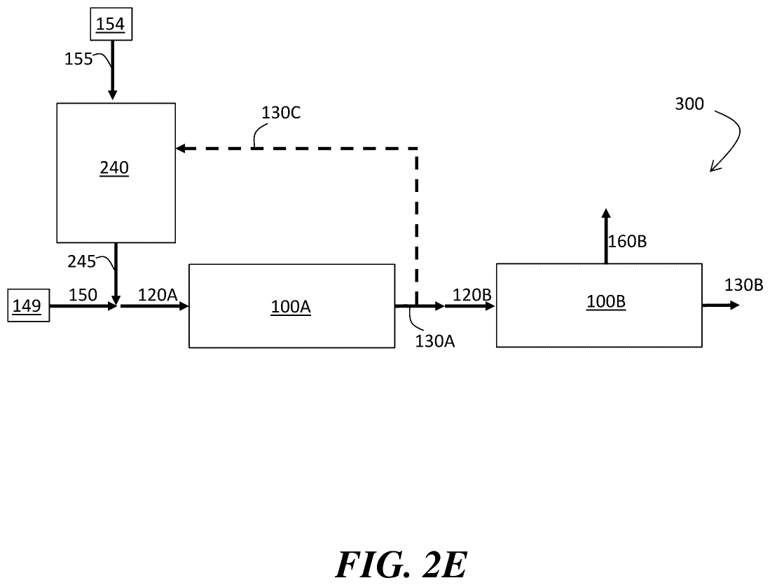

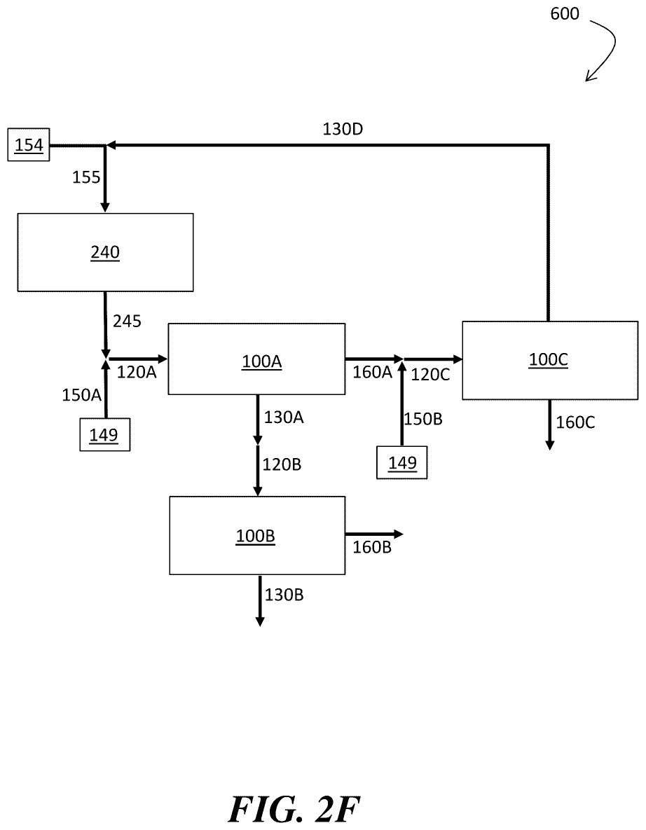

In some embodiments, treating the solution can be performed by two or more foam fractionation systems. In one set of embodiments, two or more foam fractionation systems are fluidically connected such that at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the liquid output of a first foam fractionation system enters a second foam fractionation system. For example, as shown in FIG. 2A, system 300 comprises first foam fractionation system 100A fluidically connected to second foam fractionation system 100B via first liquid output 160A. In FIG. 2A, first foam fractionation system 100A receives first input liquid solution 120A comprising all of aqueous input solution 155 and surfactant 150 from source 149. In FIG. 2A, first foamate output 130A exits first foam fractionation system 100A. Also, in FIG. 2A, first liquid output 160A exits first foam fractionation system 100A. In FIG. 2A, second foam fractionation system 100B receives second input liquid solution 120B comprising all of first liquid output 160A exiting first foam fractionation system 100A. Also in FIG. 2A, second liquid output 160B and second foamate output 130B exit second foam fractionation system 100B. In some embodiments, the second liquid output is recycled into the first foam fractionation system such that the first input liquid solution comprises at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the second liquid output. For example, as shown in FIG. 2B, second liquid output 160B is recycled into first foam fractionation system 100A such that input liquid solution 120 comprises all of second liquid output 160B.

In some embodiments, two or more foam fractionation systems are fluidically connected such that at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the foamate output exiting the first foam fractionation system enters the second foam fractionation system. For example, FIG. 2C is substantially the same as FIG. 2A except that first foam fractionation system and second foam fractionation system are fluidically connected via first foamate output 130A rather than first liquid output 160A. In FIG. 2C, second input liquid solution 120B entering second foam fractionation system 100B comprises all of first foamate output 130A such that first foamate output 130A is further processed by second foam fractionation system 100B. In some embodiments, the second foamate output can be recycled such that the first input liquid solution comprises at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the second foamate output. For example, FIG. 2D is substantially the same as FIG. 2C except that second foamate output 130B exiting second foam fractionation system 100B is recycled such that first input liquid solution 120A comprises all of second foamate output 130B.

In some embodiments, at least a portion of the first foamate output can be subsequently recycled by the first foam fractionation system such that the first liquid input solution comprises at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the first foamate output (e.g., during a second pass through the first foam fractionation system). For instance, the first foamate output may be subsequently recycled by the first foam fractionation system in a batch manner. For example, as shown in FIG. 2E, tank 240 receives and stores aqueous input solution 155 and outputs tank output 245. First input liquid solution 120A, comprising all of tank output 245 and surfactant 150, enters first foam fractionation system 100A such that first foamate output 130A, having a higher concentration of PFAS molecules than first input liquid solution 120A, exits first foam fractionation system 100A. First foamate output 130A is then transported to second foam fractionation system 100B such that second input liquid solution 120B, entering second foam fractionation system 100B, comprises all of first foamate output 130A for further processing. At this point, interior volume 115 of first foam fractionation system 100A comprises liquid having a concentration of PFAS molecules that is less than the concentration of PFAS molecules in first foamate stream 130A and less than the concentration of PFAS molecules in the liquid stored in tank 240. After an operational threshold is reached (e.g., after a threshold duration of time has passed, after a threshold volume has been outputted from the first foam fractionation system, and/or after a threshold PFAS and/or surfactant concentration has been reached in the liquid of the first foam fractionation system), foamate stream 130C, having a concentration of PFAS molecules that is now less than the concentration of PFAS molecules in the liquid of tank 240, is outputted from first foam fractionation system. Optionally, surfactant 150 (e.g., a second dose of surfactant) can be introduced into first foam fractionation system 100A after the operational threshold is reached and prior to and/or during the output of foamate stream 130C. Foamate stream 130C is then transported to tank 240 for subsequent recycling. The introduction of foamate stream 130C into the liquid of tank 240 reduces the concentration of PFAS molecules in the liquid of tank 240. First foam fractionation system 100A then receives first input liquid solution 120A, comprising all of tank output 245 which now includes recycled foamate, for additional processing (e.g., as a new batch). This batch process can be repeated any number of times to further reduce the concentrations of PFAS molecules within the liquid of tank 240.

In some embodiments, the foamate output is recycled in a continuous matter. In some such embodiments, three or more foam fractionation systems may be used. For example, as shown in FIG. 2F, first input liquid solution 120A comprises tank output 245, which has a relatively high concentration of PFAS molecules (e.g., 50,000 parts per trillion (ppt)). First foam fractionation system 100A of system 600 receives first input liquid solution 120A (e.g., at a flow rate of 1 m³/hr) and surfactant 150A (e.g., 1 ppm). First foamate output 130A then exits first foam fractionation system 100A (e.g., at a flow rate of 0.05 m³/hr) having a concentration of PFAS molecules (e.g., 990,500 ppt) that is greater than the concentration of PFAS molecules of the first input liquid solution 120A. First foamate output 130A also has a concentration of surfactant (e.g., 20 ppm) that is greater than the concentration of surfactant in the first input liquid solution 120A (e.g., 1 ppm). Second foam fractionation system 100B receives first foam fractionation output 130B for further processing. Third liquid input solution 120C, entering third foam fractionation system 100C, comprises surfactant 150B (e.g., 1 ppm) and all of first liquid output 160A exiting first foam fractionation system 100A (though it should be understood that the first liquid output and the surfactant may be introduced into the third foam fractionation system separately in some embodiments). Third foam fractionation system 100C outputs third liquid output 160C and third foamate output 130D (e.g., at a flow rate of 0.0475 m³/hr) having a concentration of PFAS molecules (e.g., 9,905 ppt) that is less than the concentration of PFAS molecules in the first input liquid solution (e.g., 50,000 ppt). Third foamate output 130D also has a concentration of surfactant (e.g., 21 ppm) that is greater than first input liquid solution 120A. Tank 240 receives third foamate output 130D for subsequent recycling of the foamate. This process may be repeated any of number of times in a continuous manner.

In some embodiments, the first foamate output has a relatively high weight ratio of PFAS molecule to surfactant compared to systems that recycle the first and/or second liquid outputs. Foamate having high weight ratios of PFAS molecules to surfactant generally are believed undergo more efficient PFAS destruction, such as using PFAS destruction systems as described elsewhere in the disclosure. For instance, foamate having high weight ratios of PFAS molecules to surfactant can, in some instances, be destroyed faster and/or with less energy expenditure than foamate having low weight ratios of PFAS molecules to surfactant.

In some embodiments, recycling at least a portion (or all) of the first foamate output through the first foam fractionation system can, surprisingly, facilitate use of lower amounts of surfactant (at least 10%, at least 20%, at least 30%, at least 40%, at least 50%, and/or up to 90%, up to 95%, or up to 99% lower by weight) to be used compared to the amounts of surfactant used in embodiments where the first and/or second product output is recycled. In some embodiments where the first foamate output of the first foam fractionation system is recycled, the input liquid solution comprises the surfactant in an amount less than or equal to 2 mg/L, less than or equal to 1.9 mg/L, less than or equal to 1.8 mg/L, less than or equal to 1.7 mg/L, less than or equal to 1.6 mg/L, less than or equal to 1.5 mg/L, less than or equal to 1.25 mg/L, less than or equal to 1.0 mg/L and/or greater than or equal to 0.01 mg/L, greater than or equal to 0.1 mg/L, or greater than or equal to 0.2 mg/L. The relatively low amount of surfactant may produce relatively low amounts of foamate compared to systems where the first and/or second liquid output is recycled, which may also facilitate PFAS destructions processes being carried in a more efficient manner. It should be understood that any number of foam fractionation systems can be used, and while the above description elaborates on a system having two foam fractionation systems, additional foam fractionation systems can be incorporated such that some or all are fluidically connected with one another via any of the inputs or the outputs of the foam fractionation systems described herein (e.g., the input liquid solution, the liquid output, and/or the foamate output). Similarly, it should also be understood that any of the outputs of the foam fractionation systems described herein (e.g., the liquid output and/or the foamate output) can be recycled such that any of the outputs may enter any of the foam fractionation systems of the overall system. As an example, while FIG. 2D shows first input liquid solution 120A comprising all of second foamate output 130B entering first foam fractionation system 100A, in some embodiments, second input liquid solution 120B can comprise some or all of second foamate output 130B such that second foamate output 130B is further processed by second foam fractionation system 100B rather than first foam fractionation system 100A as described in FIG. 2D.

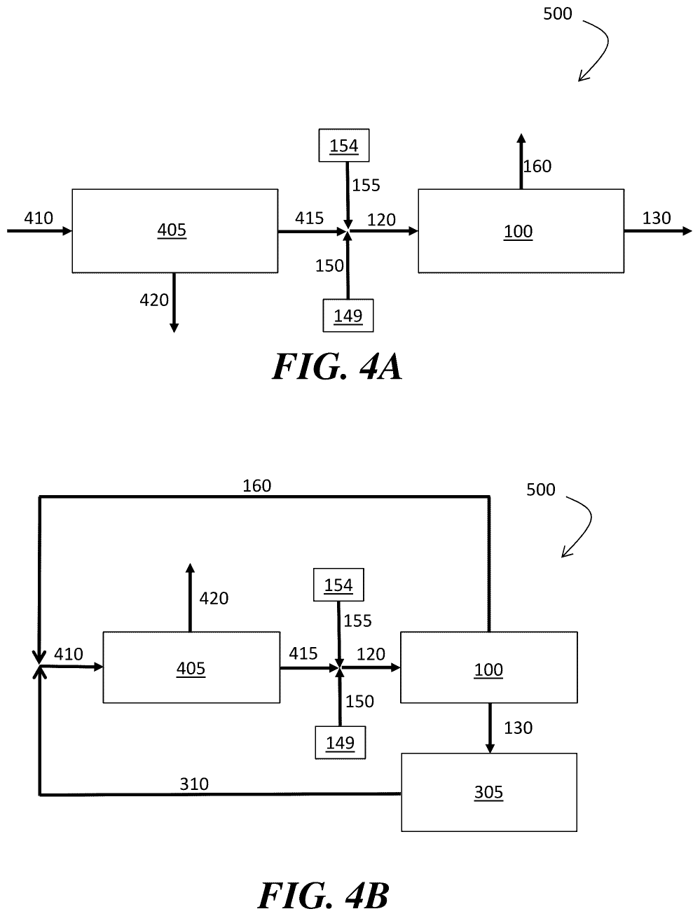

In some embodiments, a protein skimmer pretreats at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the input liquid solution before the input liquid solution enters the foam fractionation system. In some embodiments, the input liquid solution comprises at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of a protein skimmer foamate output. For example, as shown in FIG. 4A, protein skimmer 405 receives feed 410 comprising PFAS molecules. In FIG. 4A, protein skimmer foamate output 415 exits protein skimmer 405 and is combined with input liquid solution 120 such that input liquid solution 120 comprises all of protein skimmer foamate output 415 that has been pretreated by protein skimmer 405. In FIG. 4A, protein skimmer 405 is fluidically connected to foam fractionation system 100. In some embodiments, the protein skimmer outputs a protein skimmer liquid output having an amount of PFAS molecules that is lower (e.g., by a factor of at least 2; at least 5; at least 10; and/or up to 20; up to 30; or up to 50) compared to the amount of PFAS molecules in the feed. For example, as shown in FIG. 4A, protein skimmer liquid output 420 exits protein skimmer 405 and has a lower amount of PFAS molecules than feed 410.

In some embodiments, the protein skimmer concentrates the PFAS molecules such that the foam fractionation system, fluidically connected to the protein skimmer, receives at least a portion of the protein skimmer foamate output having a relatively high concentration of the PFAS molecules. In some embodiments, it is particularly advantageous to pretreat at least a portion of the liquid input solution using the protein skimmer before treatment using the foam fractionation system as advantageous concentration factors of the PFAS molecules may be achieved.

In some embodiments, the PFAS destruction system, as described elsewhere in the disclosure, is fluidically connected to the foam fractionation system that is fluidically connected to the protein skimmer. For example, FIG. 4B is substantially the same as FIG. 4A except that, system 500 comprises PFAS destruction system 305 fluidically connected to foam fractionation system 100. Additionally, in FIG. 4B, PFAS destruction output 310 and liquid output 160 is recycled such that feed 410 comprises all of PFAS destruction output 310 and liquid output 160. In some embodiments, the feed entering the protein skimmer comprises at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the PFAS destruction output. In some embodiments, the liquid output and/or the PFAS destruction output are not recycled into the protein skimmer, and therefore, in certain embodiments, the feed does not comprise a portion of the liquid output and/or a portion of the PFAS destruction output. It should be understood, as described above, that the system described in the present disclosure may involve a protein skimmer and/or a PFAS destruction system fluidically connected to the foam fractionation system, and intervening components and/or systems, including other protein skimmers, foam fractionation systems, and/or PFAS destruction systems, may be present in some embodiments. It should also be noted that, similar to other foam fractionation systems described herein, systems involving protein skimmers and/or PFAS destruction systems may recycle any output such that any input may comprise at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of one or more recycled outputs.

The systems and the methods described in the present disclosure can be used, in accordance with certain embodiments, to process any of a variety of aqueous input solutions. For example, the aqueous input solution may be in a form suitable for input into a fluidic device including but not limited to a foam fractionation system, a vessel, and/or components used for fluidic control. In some embodiments, the aqueous input solution is a single stream (e.g., a stream comprising water) comprising one or more of the PFAS molecules. In some embodiments, the feed has multiple streams comprising one or more of the PFAS molecules. In either case, in accordance with certain embodiments, the aqueous input solution forms part of an input (e.g., the liquid input solution) to the system from one or more external sources as described below. Accordingly, in some embodiments, the aqueous input solution introduces the PFAS molecules to the system for subsequent separation and/or removal. In some embodiments, any of the inputs and/or outputs comprise a portion of the aqueous input solution or contents derived from the aqueous input solution (e.g., the PFAS molecules and/or the liquid). In some embodiments, the aqueous input solution feeds the system with PFAS molecules and water (and, optionally, other liquids). That is, the aqueous input solution may serve as a source for the system such that the system may receive water and PFAS molecules for subsequent removal of the PFAS molecules from the water.

The aqueous input solution can be derived from any of a variety of different sources. For example, in some embodiments, the aqueous input solution is partially or completely derived from an industrial waste stream (e.g., discarded material from industrial and/or manufacturing processes) comprising the PFAS molecules and/or a liquid source exposed to an industrial waste stream comprising the PFAS molecules. In some embodiments, in addition to water and PFAS molecules, the aqueous input solution can further comprise any of a variety of contaminants, waste products, and/or compounds that may be undesirable in any of a variety of applications. In some embodiments, the aqueous input solution is in the form of one or more streams. In some embodiments, the aqueous input solution is a single stream comprising water and PFAS molecules. That is, the aqueous input solution may be in the form of a single flowing stream comprising water and PFAS molecules. In some embodiments, the aqueous input solution comprises multiple streams each comprising at least a portion of water and/or PFAS molecules. In some embodiments, multiple streams are combined prior to input into a fluidic device (e.g., foam fractionation system), within the fluidic device, or within the vessel. Prior to their combination, each of the multiple streams may have different compositions. As an example, some of the multiple streams may comprise a relatively high amount of PFAS molecules while others may comprise a relatively low amount of PFAS molecules. In other embodiments, the multiple streams are input in the fluidic device (e.g., foam fractionation system) via separate inlets.

It should be understood that the aqueous input solution can enter through one or more inlets fluidically connected to the interior volume of the vessel, in certain embodiments. The aqueous input solution, in some embodiments, can enter the interior volume of the vessel via a different inlet than the inlet by which the input liquid solution enters the interior volume of the vessel. It is not necessary for the aqueous input solution to be mixed and/or combined within the input liquid solution prior to entry into the vessel, and instead, in some embodiments, the aqueous input solution can be mixed and/or combined with the rest of the liquid in the interior volume of the vessel once introduced to the interior volume of the vessel. For example, as shown in FIG. 1A, input liquid solution 120 comprising all of aqueous input solution 155 enters vessel 105 via liquid solution entry 145. However, aqueous input solution 155 does not necessarily have to enter vessel 105 via liquid solution entry 145, and in some embodiments, aqueous input solution 155 can enter vessel 105 via one or more inlets (not shown) on the vessel.

In some embodiments, the PFAS molecules comprise at least one perfluoroalkyl moiety (—CₙF₂ₙ₊₁). In some embodiments, the PFAS molecules comprises a perfluorinated methyl group (—CF₃). In some embodiments, the PFAS molecules comprise and/or a perfluorinated methylene group (—CF₂—). Examples of perfluoroalkyl moieties include but are not limited to perfluorooctane (R—C₈F₁₇), perfluorohexane (R—C₆F₁₃), and/or perfluorobutane (R—C₄F₉), where “R” can be any of a variety of head groups including but not limited to a carboxylic acid, sulfonic acid, and/or phosphonic acid. In some embodiments, the PFAS molecules comprise perfluorooctanoic acid, perfluorooctanesulfonic acid, perfluorohexanesulphonic acid, perfluorobutanesulfonic acid, perfluorobutanoic acid, perfluoroalkyl acids (PFAA), perfluoroalkyl carboxylic acids, perfluoroalkyl carboxylates, perfluoroalkane sulfonic acids, perfluoroalkance sulfonates (PFSA), perfluoroalkyl ether acids, perfluoroalkance sulfonyl fluorides (PASF), perfluoroalkane sulfonamides (FASA), perfluoroalkanoyl fluorides (PFA), perfluoroalkyl iodides (PFAI), perfluoroalkyl aldehydes, fluorotelomer substances, polyfluoroalkane sufonamido substances, polyfluoroalkyl ether acids, chloropolyfluoroalkyl ether acids, and/or chloropolyfluoroalkyl acids. In some embodiments, the PFAS molecules comprises one or more molecules disclosed in the “Per- and Polyfluoroalkyl Substances (PFAS) Report” by the Joint Subcommittee on Environment, Innovation, and Public Health Per- and Polyfluoroalkyl Substances Strategy Team of the National Science and Technology Council published in March 2023, which is incorporated herein by reference in its entirety for all purposes.

In some embodiments, at least some (e.g., at least 10 mol %, at least 25 mol %, at least 50 mol %, at least 75 mol %, at least 90 mol %, at least 95 mol %, at least 99 mol %, or all) of the PFAS molecules are anionic. For example, some of the PFAS molecules may comprise a carboxylate group, a phosphate group, and/or a sulfonate group. In some embodiments, at least some (e.g., at least 10 mol %, at least 25 mol %, at least 50 mol %, at least 75 mol %, at least 90 mol %, at least 95 mol %, at least 99 mol %, or all) of the PFAS molecules are anionic when present in the feed. In some embodiments, at least some (e.g., at least 10 mol %, at least 25 mol %, at least 50 mol %, at least 75 mol %, at least 90 mol %, at least 95 mol %, at least 99 mol %, or all) of the PFAS molecules comprise a negatively charged terminal group. In some embodiments, at least some (e.g., at least 10 mol %, at least 25 mol %, at least 50 mol %, at least 75 mol %, at least 90 mol %, at least 95 mol %, at least 99 mol %, or all) of the PFAS molecules comprise a polar portion (e.g., a carboxylate group, a phosphate group, a sulfonate group). In some embodiments, at least some (e.g., at least 10 mol %, at least 25 mol %, at least 50 mol %, at least 75 mol %, at least 90 mol %, at least 95 mol %, at least 99 mol %, or all) of the PFAS molecules comprise a nonpolar portion (e.g., an alkyl chain partially or fully saturated with fluorine atoms). The PFAS molecules may have any of a variety of molecular weights. In some embodiments, the PFAS molecules have a molecular weight of at least 100 g/mol, at least 150 g/mol, at least 200 g/mol, at least 250 g/mol, at least 300 g/mol, at least 400 g/mol, at least 500 g/mol, at least 600 g/mol, and/or up to 800 g/mol, up to 1000 g/mol, or more. In some embodiments, at least some (e.g., at least 10 mol %, at least 25 mol %, at least 50 mol %, at least 75 mol %, at least 90 mol %, at least 95 mol %, at least 99 mol %, or all) of the PFAS molecules comprise an alkyl chain comprising at least 2 carbon atoms, at least 4 carbon atoms, at least 6 carbon atoms, at least 8 carbon atoms, at least 10 carbon atoms, at least 12 carbon atoms, at least 14 carbon atoms, at least 16 carbon atoms, at least 18 carbon atoms, at least 20 carbon atoms, and/or up to 25 carbon atoms, up to 30 carbon atoms, or more.

The inputs described throughout the present disclosure may comprise and/or be fluidically connected to a source of a surfactant. In some embodiments, the inputs described herein (e.g., the liquid input solution) comprise surfactant. In some embodiments, the surfactant is amphiphilic. In accordance with some embodiments, the surfactant can assist with the separation of the PFAS molecules from the input liquid solution. In some embodiments, the surfactant can be dosed into the vessel via the input liquid solution. In some embodiments, the surfactant is dosed in a continuous manner. That is, a continuous supply of the surfactant is, in some embodiments, introduced with limited interruption. In some embodiments, the surfactant is dosed intermittently. That is, a supply of surfactant is, in some embodiments, introduced in batches (e.g., intermittent doses of discrete amounts).

In some embodiments, the source of surfactant is introduced into the vessel via one or more inlets. In some embodiments, the surfactant can enter the interior volume of the vessel via one or more inlets fluidically connected to the interior volume of the vessel. In some embodiments, the source of surfactant can enter the interior volume of the vessel by one or more different inlets than the inlets used to introduce the liquid input solution to the interior volume of the vessel. While the source of surfactant has been previously described as a portion of the input liquid solution, it should be understood that the source of surfactant can enter the interior volume of the vessel separately from the input liquid solution in certain embodiments.

In some embodiments, the surfactant comprises a cationic surfactant. That is, the surfactant comprises, in some embodiments, a portion having a net positive charge. In some embodiments, the cationic surfactant may interact with the PFAS molecules such that the portion having a net positive charge interacts with a portion of the PFAS molecules having a net negative charge to form a micelle. The electrostatic interaction between the portion of the PFAS having a net negative charge and the portion of the cationic surfactant having a net positive charge may allow for the formation of relatively stable and relatively large micelles which would aid removal using the semi-permeable membrane. Advantageously, the electrostatic interaction between the cationic surfactant and the PFAS molecules may allow for the removal of relatively short-chain PFAS molecules (e.g., perfluorobutanoic acid, perfluorobutanesulfonic acid). Accordingly, the electrostatic interaction between the cationic surfactant and the PFAS molecules may promote the separation of short-chain PFAS compounds.

The cationic surfactant described herein can comprise any of a variety of compounds. In some embodiments, the cationic surfactant comprises cetyltrimethylammonium bromide (CTAB) and/or trimethyloctylammonium bromide (OTAB). In some embodiments, the cationic surfactant comprises a hydrophobic moiety. In some embodiments, the hydrophobic moiety comprises an alkyl group comprising at least 2, at least 5, at least 10, at least 12, at least 14, at least 16, at least 18, at least 20, at least 22, at least 24, or at least 25 carbon atoms (and/or up to 25 carbon atoms, up to 30 carbon atoms, or more). In some embodiments, the cationic surfactant comprises a hydrophilic group comprising any of a variety of salts. In some embodiments, the hydrophilic group comprises a quaternary ammonium salt. That is, the hydrophilic group comprises a positively-charged ion of the general structure [NR₄]⁺ where R is an alkyl group, an aryl group, or an organyl group and can ionically interact with halogens (e.g., fluorine, chlorine, bromine, iodine).

In some embodiments, the surfactant comprises an anionic and/or a non-ionic surfactant. The anionic surfactant comprises, in some embodiments, a portion having a net negative charge. In some embodiments, the non-ionic surfactants may not have net charge. In certain embodiments, the anionic and/or non-ionic surfactants may allow for the removal of long-chain PFAS molecules and/or other contaminants and may have a relatively lower cost than surfactants that remove short-chain PFAS molecules. Accordingly, in some embodiments, the anionic and/or non-ionic surfactant may, advantageously, be introduced into any input of the system (e.g., the input liquid solution) to remove long-chain PFAS molecules, such that the cationic surfactant (which may have a relatively high cost) may be introduced afterward to target short-chain PFAS molecules to limit the consumption of the cationic surfactant by long-chain PFAS molecules. In some embodiments, the anionic and/or non-ionic surfactants can be introduced as co-surfactants or as an alternative to the cationic surfactant. In some embodiments, the anionic and/or non-ionic surfactants can be introduced into the vessel, the separator(s), or any one of the various inputs and/or outputs described herein.

In some embodiments, the surfactant comprises one type of surfactant. In other embodiments, the surfactant comprises more than one type of surfactant. In some embodiments, the surfactant comprises a mixture of surfactants comprising the cationic surfactant, the anionic surfactant, and/or the non-ionic surfactant.

In some embodiments, the length of the largest alkyl group in the surfactant is similar in length to the largest alkyl group of the PFAS molecules. In some embodiments, the number of carbon atoms in the largest alkyl group in the cationic surfactant is within 10, within 9, within 8, within 7, within 6, within 5, within 4, within 3, within 2, or within 1 (or the same as) the number of carbon atoms in the largest alkyl group of the PFAS molecules.

In some embodiments, the surfactant is present in the input liquid solution in a relatively low amount. In some embodiments, the input liquid solution comprises the surfactant in an amount less than or equal to 2 mg/L, less than or equal to 1.9 mg/L, less than or equal to 1.8 mg/L, less than or equal to 1.7 mg/L, less than or equal to 1.6 mg/L, less than or equal to 1.5 mg/L, less than or equal to 1.25 mg/L, less than or equal to 1.0 mg/L and/or greater than or equal to 0.01 mg/L, greater than or equal to 0.1 mg/L, or greater than or equal to 0.2 mg/L. Combinations of these ranges are also possible (e.g., less than or equal to 2 mg/L and greater than or equal to 0.01 mg/L). Other ranges are also possible. The amount of surfactant present in the input liquid solution is determined by measuring the concentration of the surfactant in the interior volume of the vessel For example, as shown in FIG. 1A, the amount of surfactant present in the input solution is determined by measuring the concentration of the surfactant at liquid solution entry 145 of vessel 105 and/or in interior volume 115 of vessel 105.

In some embodiments, the surfactant is present in liquid in the interior volume of the vessel. In some embodiments, the liquid in the interior volume of the vessel comprises the surfactant in an amount of less than or equal to 2 mg/L, less than or equal to 1.9 mg/L, less than or equal to 1.8 mg/L, less than or equal to 1.7 mg/L, less than or equal to 1.6 mg/L, less than or equal to 1.5 mg/L, less than or equal to 1.25 mg/L, less than or equal to 1.0 mg/L and/or greater than or equal to 0.01 mg/L, greater than or equal to 0.1 mg/L, or greater than or equal to 0.2 mg/L. Combinations of these ranges are also possible (e.g., less than or equal to 2 mg/L and greater than or equal to 0.01 mg/L). Other ranges are also possible. The concentration of surfactant can be measured using any of a variety of suitable methods such as a total organic carbon (TOC) analyzer and/or liquid chromatography (LC).

In some embodiments, the surfactant is present in the aqueous input solution in a somewhat greater amount after at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the aqueous input solution has undergone one or more pretreatment processes (e.g., using a protein skimmer). In some embodiments, the aqueous input solution comprises the surfactant in an amount greater than or equal to 5 mg/L (or greater than or equal to 6 mg/L, greater than or equal to 7 mg/L, greater than or equal to 8 mg/L, greater than or equal to 9 mg/L, or greater than or equal to 10 mg/L) and/or less than or equal to 50 mg/L (or less than or equal to 49.9 mg/L, less than or equal to 49 mg/L, less than or equal to 45 mg/L) after at least a portion of the aqueous input solution has undergone one or more pretreatment processes. Combinations of these ranges are possible (e.g., greater than or equal to 5 mg/L and less than or equal to 50 mg/L). Other ranges are also possible.

In some embodiments, the input liquid solution comprises the surfactant in an amount greater than or equal to the critical micelle concentration (CMC). In some embodiments, the surfactant is present in the input liquid solution in an amount sufficient such that at least some of the PFAS molecules are associated with micelles comprising the surfactant. The CMC may vary based on various parameters including but not limited to temperature, valency of the counter-ion of the surfactant, the size of alkyl groups of the surfactant, and/or the presence of electrolytes in the input liquid solution. Accordingly, in some embodiments, these parameters may be varied such that the concentration of the surfactant in the input liquid solution is greater than or equal to the CMC. In some embodiments, the foam fractionation system comprises a foam separation device. In some embodiments, the foam separation device is configured to impart a vacuum on all or a portion of the contents in the vessel. In some embodiments, the foam separation device imparts a vacuum within the elongated portion. For example, the foam separation device (not shown) may impart a vacuum onto elongated portion 125 shown in FIG. 1A. In some embodiments, the foam separation device imparts a vacuum on the outlet from which the foamate output exits the vessel. For example, the foam separation device (not shown) may impart a vacuum onto outlet 235 from which foamate output 130 exits vessel 105. The foam separation device may allow for the separation of foam from liquid, when present, in the interior volume and allow for the flow of foam through the foamate output. As described elsewhere in the disclosure, the foam fractionation system described herein, according to certain embodiments, can separate PFAS molecules using a relatively low amount of surfactant, and the foam separation device may advantageously facilitate the separation of foam from the liquid under such conditions. When the amount of surfactant is relatively low, in some embodiments, the injected bubbles from the bubblers may not be sufficient to induce flow of the foamate output, and accordingly, the foam separation device can, in some cases, mitigate this. In some embodiments, the foam separation device is configured to impart a vacuum on a portion of the foam within the vessel such that at least some of the contents liquify. Liquification of the foam after separation from the rest of the liquid in the vessel may further allow the foamate output to flow.

In some embodiments, the foam separation device is positioned along the elongated portion of the vessel. In some embodiments, the foam separation device can move along the long axis of the elongated portion of the vessel.

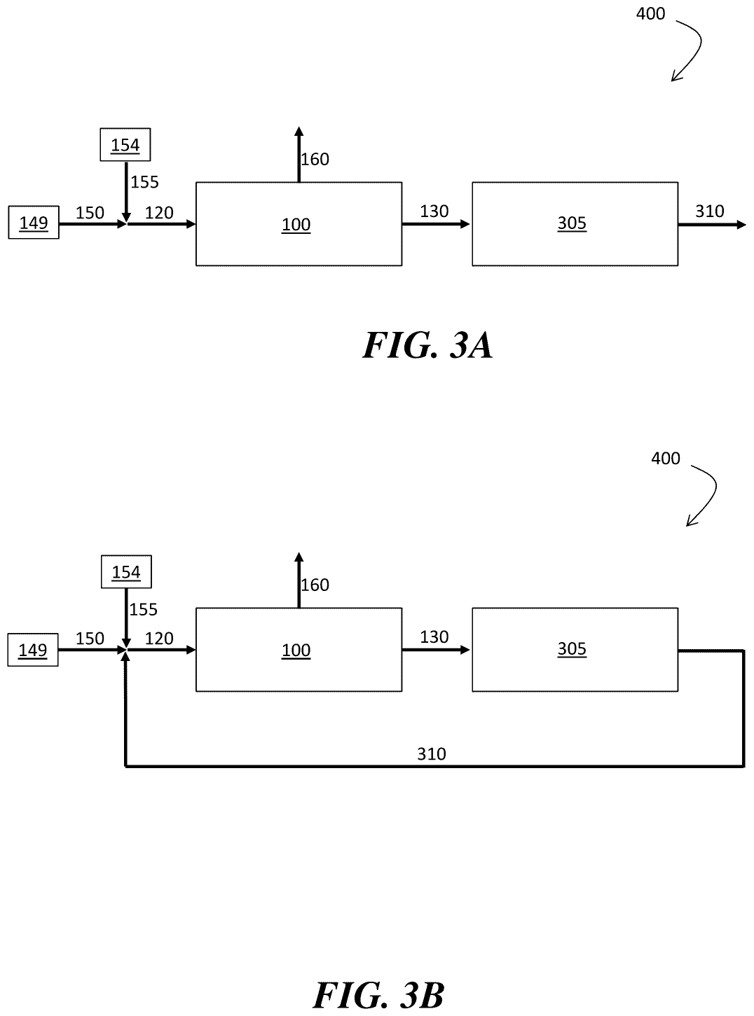

In some embodiments, systems and methods described herein involve a PFAS destruction system and/or step. The PFAS destruction system can include, for example, a conduit and/or vessel within which PFAS is treated such that it is destroyed. In some embodiments, at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the foamate output comprising the one or more PFAS molecules enters a PFAS destruction system (and/or are subject to a PFAS destruction step) such that at least some (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the PFAS molecules entering the PFAS destruction system (and/or are subject to the PFAS destruction step) are destroyed. For example, as shown in FIG. 3A, system 400 comprises foam fractionation system 100 and PFAS destruction system 305. All of foamate output 130 exiting foam fractionation system 100 enters PFAS destruction system 305 such that at least some of the PFAS molecules in foamate output 130 are destroyed by PFAS destruction system 305.

In some embodiments, a PFAS destruction output exits the PFAS destruction system. For example, as shown in FIG. 3A, PFAS destruction output 310 exits PFAS destruction system 305. In some embodiments, the input liquid solution entering the foam fractionation system comprises at least a portion (e.g., at least 1 wt %, at least 5 wt %, at least 10 wt %, at least 20 wt %, at least 30 wt %, at least 40 wt %, at least 50 wt %, at least 60 wt %, at least 70 wt %, at least 80 wt %, at least 90 wt %, at least 99 wt %, or 100 wt %) of the PFAS destruction output. For example, as shown in FIG. 3B, input liquid solution 120 entering foam fractionation system 100 comprises all of PFAS destruction output 310. In some embodiments, the PFAS destruction output comprises PFAS molecules that were not destroyed by the PFAS destruction system, and by recycling the PFAS destruction output back into the foam fractionation system such that they are reprocessed by the foam fractionation system and/or the PFAS destruction system.

In some embodiments, after the one or more PFAS molecules are separated from the remainder of the aqueous solution into the foamate output of the foam fractionation system, the PFAS molecules may undergo a destruction process. In some embodiments, the destruction process comprises exposing the one or more PFAS molecules to conditions that facilitate the breakdown of the PFAS molecules (e.g., a hydrothermal process configured to destroy some PFAS molecules). In some embodiments, such conditions include but are not limited to relatively high temperatures and/or relatively high pressures. In one set of embodiments, a foam fractionation system is described. In some embodiments, the foam fractionation system comprises a vessel comprising: a vessel body portion comprising an interior volume configured to process an input liquid solution; an elongated portion comprising a foamate output at a distal end of the elongated portion with respect to the interior volume, the foamate output in fluid communication with the interior volume; a liquid solution entry in fluid communication with the interior volume; a liquid output in fluid communication with the interior volume; and a bubbler configured to: receive a gas input, and inject bubbles into the interior volume; wherein: at least 80% of the total volume of the bubbles is made up of bubbles having a largest cross-sectional dimension of greater than or equal to 1 micron and less than or equal to 200 microns; and the elongated portion has: a flowpath length along a long axis along a direction of fluid flow from the interior volume to the foamate output; and an average cross-sectional area along the long axis of the elongated portion, wherein a ratio of the flowpath length divided by the cross-sectional area is greater than or equal to 1 cm/cm². For example, as shown in FIGS. 1A-1E, foam fractionation system 100 comprises vessel 105 comprising: vessel body portion 110 comprising interior volume 115 configured to process input liquid solution 120; elongated portion 125 comprising foamate output 130 at distal end 135 of elongated portion 125 with respect to interior volume 115, foamate output 130 in fluid communication with interior volume 115; liquid solution entry 145 in fluid communication with interior volume 115; liquid output 230 in fluid communication with interior volume 115; and bubbler 165 configured to: receive gas input 170, and inject bubbles 175 into interior volume 115; wherein: at least 80% of the total volume of bubbles 175 is made up of bubbles having a largest cross-sectional dimension of greater than or equal to 1 micron and less than or equal to 200 microns; and elongated portion 125 has: flowpath length L1 along long axis 190 along direction of fluid flow 180 from interior volume 115 to foamate output 130; and average cross-sectional area 185B along long axis 190, wherein a ratio of flowpath length L1 divided by average cross-sectional area 185B is greater than or equal to 1 cm/cm².

In some embodiments, the foam fractionation system comprises: a vessel comprising: a vessel body portion comprising an interior volume configured to process an input liquid solution; an elongated portion comprising a foamate output at a distal end of the elongated portion with respect to the interior volume, the foamate output in fluid communication with the interior volume; a liquid solution entry in fluid communication with the interior volume; a liquid output in fluid communication with the interior volume; and a bubbler configured to: receive a gas input, and inject bubbles into the interior volume; wherein: at least 80% of the total volume of the bubbles is made up of bubbles having a largest cross-sectional dimension of greater than or equal to 1 micron and less than or equal to 200 microns; and the elongated portion has an average cross-sectional area perpendicular to a direction of fluid flow from the interior volume to the foamate output, and a ratio of the volume of the interior volume divided by the average cross-sectional area of the elongated portion is greater than or equal to 2000 cm. For example, as shown in FIGS. 1A-1E, foam fractionation system 100 comprises: vessel 105 comprising: vessel body portion 110 comprising interior volume 115 configured to process input liquid solution 120; elongated portion 125 comprising foamate output 130 at distal end 135 of elongated portion 125 with respect to interior volume 115, foamate output 130 in fluid communication with interior volume 115; liquid solution entry 145 in fluid communication with interior volume 115; liquid output 230 in fluid communication with interior volume 115; and bubbler 165 configured to: receive gas input 170, and inject bubbles 175 into interior volume 115; wherein: at least 80% of the total volume of bubbles 175 is made up of bubbles having a largest cross-sectional dimension of greater than or equal to 1 micron and less than or equal to 200 microns; and elongated portion 125 has average cross-sectional area 185B perpendicular to direction of fluid flow 180 from interior volume 115 to foamate output 130, and a ratio of the volume of interior volume 115 divided by average cross-sectional area 185B of elongated portion 125 is greater than or equal to 2000 cm.

In some embodiments, the foam fractionation system comprises: a vessel comprising: a vessel body portion comprising an interior volume configured to process an input liquid solution; an elongated portion comprising a foamate output at a distal end of the elongated portion with respect to the interior volume, the foamate output in fluid communication with the interior volume; a liquid solution entry in fluid communication with the interior volume; a liquid output in fluid communication with the interior volume; and a bubbler configured to: receive a gas input, and inject bubbles into the interior volume; wherein: at least 80% of the total volume of the bubbles is made up of bubbles having a largest cross-sectional dimension of greater than or equal to 1 micron and less than or equal to 200 microns; and the vessel body portion comprises a main body portion and a taper portion, wherein the main body portion is connected to the elongated portion via the taper portion. For example, as shown in FIGS. 1A-1E, foam fractionation system 100 comprises: vessel 105 comprising: vessel body portion 110 comprising interior volume 115 configured to process input liquid solution 120; elongated portion 125 comprising foamate output 130 at distal end 135 of elongated portion 125 with respect to interior volume 115, foamate output 130 in fluid communication with interior volume 115; liquid solution entry 145 in fluid communication with interior volume 115; liquid output 230 in fluid communication with interior volume 115; and bubbler 165 configured to: receive gas input 170, and inject bubbles 175 into interior volume 115; wherein: at least 80% of the total volume of bubbles 175 is made up of bubbles having a largest cross-sectional dimension of greater than or equal to 1 micron and less than or equal to 200 microns; and vessel body portion 110 comprises main body portion 210 and taper portion 205, wherein main body portion 210 is connected to elongated portion 125 via taper portion 205.

U.S. Provisional Patent Application No. 63/645,780, filed May 10, 2024, and entitled “Systems, Articles, and Methods Related to Foam Fractionation of Fluids,” is incorporated herein by reference in its entirety for all purposes.

The following examples are intended to illustrate certain embodiments of the present invention, but do not exemplify the full scope of the invention.

### Example 1

This example describes the separation of one or more PFAS molecules from water.

The separation and/or concentration of PFAS molecules was evaluated using an embodiment of the foam fractionation systems describe herein under two different surfactant dosages. The surfactant was dosed in an input liquid solution comprising a variety of PFAS molecules including perfluorobutanoic acid (PFBA), perfluoroheptanoic acid (PFHpA), perfluorohexanoic acid (PFHxA), perfluorohexanesulphonic acid (PFHxS), 6:2-fluorotelomersulfonic acid (6-2FtS), perfluorooctanoic acid (PFOA), perfluorooctanesulfonic acid (PFOS), perfluorononanoic acid (PFNA), and perfluorobutanesulfonic acid (PFBS). The input liquid solution was then treated by the foam fractionation system. Table 1 depicts the concentration of the PFAS molecules described above in the input liquid solution, the liquid output, and the foamate output. The input liquid solution was treated using a single-stage foam fractionation system with a surfactant dosage of 1 mg/L (about 1 ppm). The concentrating factor can be calculated by dividing the sum of the concentration of each type of PFAS molecule in the foamate output by the sum of the concentration of each type of PFAS molecule in the input liquid solution prior to treatment by the foam fractionation system. With a surfactant dosage of 1 mg/L, the concentrating factor was 2411.

TABLE 1
Concentration of PFAS molecules in the input liquid solution, the liquid
output, and the foamate output with a 1 mg/L surfactant dosage.

| | | | | | | | | | | Total |
|---|---|---|---|---|---|---|---|---|---|---|
| | PFBA | PFHpA | PFHxA | PFHxS | 6-2FtS | PFOA | PFOS | PFNA | PFBS | PFAS |
| | μg/L | μg/L | μg/L | μg/L | μg/L | μg/L | μg/L | μg/L | μg/L | μg/L |
| | (ppb) | (ppb) | (ppb) | (ppb) | (ppb) | (ppb) | (ppb) | (ppb) | (ppb) | (ppb) |
| Input | 0.109 | 0.002 | 0.002 | 0.208 | 0.002 | 0.245 | 0.148 | 0 | 0.151 | 0.869 |
| Liquid | (0.109) | (0.002) | (0.002) | (0.208) | (0.002) | (0.245) | (0.148) | (0) | (0.151) | (0.869) |
| Solution | | | | | | | | | | |
| Liquid | 0.087 | 0 | 0 | 0.001 | 0.001 | 0.001 | 0.002 | 0 | 0 | 0.092 |
| output | (0.087) | (0) | (0) | (0.001) | (0.001) | (0.001) | (0.002) | (0) | (0) | (0.092) |
| Foamate | 152.59 | 2.088 | 4.477 | 709.16 | 1.054 | 635.02 | 588.14 | 0.369 | 1.7 | 2094.61 |
| Output | (152.590) | (2.088) | (4.477) | (709.163) | (1.054) | (635.023) | (588.147) | (0.369) | (1.7) | (2094.61) |

A similar experiment was conducted using a single-stage foam fractionation system, but rather than a surfactant dosage of 1 mg/L, a surfactant dosage of 2 mg/L was used. Table 1 depicts the concentration of the PFAS molecules described above in the input liquid solution, the liquid output, and the foamate output with a 2 mg/L surfactant dosage. The concentrating factor here, calculated in the same manner as described above, was 1458. Surprisingly, a lower dosage of the surfactant resulted in a relatively larger concentrating factor indicating that the foam fractionation system can be used with relatively low surfactant dosages.

TABLE 2
Concentration of PFAS molecules in the input liquid solution, the liquid
output, and the foamate output with a 2 mg/L surfactant dosage.

| μg/L | | | | | | | | | | Total |
|---|---|---|---|---|---|---|---|---|---|---|
| (ppb) | PFBA | PFHpA | PFHxA | PFHxS | 6-2FtS | PFOA | PFOS | PFNA | PFBS | PFAS |
| Input | 0.135 | 0.001 | 0.002 | 0.115 | 0.003 | 0.282 | 0.199 | 0 | 0.155 | 0.893 |
| Liquid | (0.135) | (0.001) | (0.002) | (0.115) | (0.003) | (0.282) | (0.199) | (0) | (0.155) | (0.893) |
| Solution | | | | | | | | | | |
| Liquid | 0.020 | 0 | 0 | 0.001 | 0.002 | 0.001 | 0.002 | 0 | 0 | 0.026 |
| output | (0.020) | (0) | (0) | (0.001) | (0.002) | (0.001) | (0.002) | (0) | (0) | (0.026) |
| Foamate | 161.118 | 3.325 | 3.626 | 214.157 | 0.783 | 451.971 | 451.576 | 1.007 | 13.676 | 1301.238 |
| Output | (161.118) | (3.325) | (3.626) | (214.157) | (0.783) | (451.971) | (451.576) | (1.007) | (13.676) | (1301.238) |

An experiment was also conducted using a two-stage foam fractionation system, with a surfactant dosage of 1 mg/L introduced at the beginning of the first stage to fractionate higher concentrations of PFAS. The elongated portion of the foam fractionation system in stage 1 had a smaller diameter compared the diameter of the elongated portion of the foam fractionation system in stage 2. Such a configuration may facilitate removal of surfactant at lower concentrations. The overall surfactant removal in the two-stage fractionation system exceeded 95%, compared to approximately 80% in the single-stage process. Table 3 summarizes the results. In this experiment, PFAS concentration in the foamate was not measured; however, the total foamate volume accounted for only 0.037% of the feed water, indicating a concentrating factor greater than 2,000.

TABLE 3
Concentration of PFAS molecules in the input liquid solution
and the liquid output with a 1 mg/L surfactant dosage.

| | PFBA | PFOA | PFOS | PFBS |
|---|---|---|---|---|
| | μg/L | μg/L | μg/L | μg/L |
| | (ppb) | (ppb) | (ppb) | (ppb) |
| Input Liquid | 1.170 | 0.509 | 0.366 | 0.648 |
| Solution | (1.170) | (0.509) | (0.366) | (0.648) |
| Liquid output | 0.693 | 0.0006 | 0.0023 | 0.0013 |
| | (0.693) | (0.0006) | (0.0023) | (0.0013) |

### Example 2

This example describes another set of experiments involve a foam fractionation system comprising an ultrafiltration membrane. To compare the concentrating factor of foam fractionation systems described in the present disclosure with those seen in typical protein skimmers, two single-stage foam fractionation system were used to treat the input liquid solution having a surfactant dosage of 1 mg/L and 2 mg/L. The input liquid solution was also used treated using a single stage protein skimmer with similar surfactant dosages. Additionally, a comparative test was also performed in the same fractionation system by introducing larger bubble size (>1 mm) for fractionation. The resulting concentrating factors and removal rates are shown in Table 3 along with the respective surfactant dosages for each stage. While the protein skimmer stage was able to achieve a concentrating factor of 25, the single stage foam fractionation systems were able to achieve concentrating factors greater than 2300. The concentrating factor dropped to 500 when larger bubbles were injected. The removal rates shown in Table 4 can be determined by subtracting the quotient of the concentration of PFAS molecules in the liquid output divided by the concentration of PFAS molecules in the input liquid solution from 1.

TABLE 4
Concentrating factor and removal rate of PFAS molecules of foam fractionation systems

| | | | | Short | | |
|---|---|---|---|---|---|---|
| | | | | Chain | | |
| | | | Total | (<4C) | | |
| | | | PFAS | PFAS | | |
| | | | in Input | in Input | | |
| | | CTAB | Liquid | Liquid | | |
| | | Dosage | Solution | Solution | | PFAS |
| | | mg/L | μg/L | μg/L | Concentrating | Removal |
| Setup | Stages | (ppm) | (ppb) | (ppb) | Factor (CF) | Rate (%) |
| Foam Fractionation System | Single | 2 | 0.18 | 0.03 | 2347 | 87.81 |
| | Stage | | (0.18) | (0.03) | | |
| Foam Fractionation System | Single | 1 | 0.14 | 0.02 | 3943 | 84.15 |
| | Stage | | (0.14) | (0.02) | | |
| Foam Fractionation system | Single | 1 | 0.16 | 0.02 | 498 | N/A |
| (macrobubble, bubble size > 1 mm) | stage | | (0.16) | | | |
| Protein Skimmer | Single | 1-2 | 0.2 | 0.04 | 25 | 83.69~86.89 |
| | Stage | | (0.2) | (0.04) | | |

### Example 3

This example describes comparative experimental data. The foam fractionation system used in this example was substantially the same as the system used in Example 1, except the bubbler was configured to introduce macrobubbles into the interior volume of the vessel, in this example, as opposed to microbubbles used in Example 1 and Example 2. The input liquid solution has 1 ppm of CTAB as the surfactant. Compared with the results in Example 1 and Example 2, the use of macrobubbles is observed to reduce the enrichment ratio and removal rate of the PFAS molecules. In this comparative experiment, the PFOA and PFOS concentration did not meet the Environmental Protection Agency's discharge guideline of 4 ppt.

TABLE 5
Enrichment ratio and removal rate of PFAS molecules
of foam fractionation systems using macrobubbles

| | PFOA | PFOS |
|---|---|---|
| | (ppb) | (ppb) |
| Feed | 0.542101 | 0.150566 |
| Effluent | 0.015478 | 0.019344 |
| Foamate | 202.0155 | 160.6555 |
| Enrichment ratio | 372.65 | 1067.01 |
| Removal Rate | 97.14% | 87.15% |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage. As used herein, “mol %” is an abbreviation of mole percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for treating a solution comprising one or more per- and/or polyfluoroalkyl substance (PFAS) molecules, comprising:
exposing an aqueous solution comprising one or more PFAS molecules and a surfactant to bubbles such that at least some of the PFAS molecules are associated with at least some of the bubbles, thereby forming PFAS-associated bubbles, wherein at least 80% of the total volume of the bubbles is made up of bubbles having a largest cross-sectional dimension of greater than or equal to 1 micron and less than or equal to 200 microns; and
separating at least some of the PFAS-associated bubbles from a remainder of the aqueous solution, thereby forming:
a foamate comprising the at least some of the PFAS-associated bubbles, and
a liquid output comprising at least a portion of the remainder of the aqueous solution, the liquid output having a concentration of PFAS molecules that is less than that of the aqueous solution.

2. A method for treating a solution comprising one or more per- and/or polyfluoroalkyl substance (PFAS) molecules, comprising:
exposing an aqueous solution comprising one or more PFAS molecules and a surfactant to bubbles such that at least some of the PFAS molecules are associated with at least some of the bubbles, thereby forming PFAS-associated bubbles; and
separating at least some of the PFAS-associated bubbles from a remainder of the aqueous solution, thereby forming:
a foamate comprising the at least some of the PFAS-associated bubbles, wherein the foamate comprises the one or more PFAS molecules at a concentration that is greater than that of the aqueous solution by a factor of greater than or equal to 50, and
a liquid output comprising at least a portion of the remainder of the aqueous solution, the liquid output having a concentration of PFAS molecules that is less than that of the aqueous solution.

3. The method of claim 1, wherein the surfactant is present in the aqueous solution at a concentration of less than or equal to 2 mg/L.

4. The method of claim 1, further comprising exposing at least a portion of the liquid output to the bubbles such that at least some of the PFAS molecules are associated with at least some of the bubbles, wherein the at least a portion of the liquid output comprises the surfactant present at a concentration of less than or equal to 50 mg/L and greater than or equal to 5 mg/L when exposed to the bubbles.

5. The method of claim 1, wherein a ratio of a concentration of the one or more PFAS molecules in the foamate to the concentration of the one or more PFAS molecules in the aqueous solution is greater than or equal to 50.

6. The method of claim 1, further comprising exposing the one or more PFAS molecules to conditions that facilitate breakdown of the PFAS molecules.

7. The method of claim 1, wherein after exposing the aqueous solution to bubbles, the foamate is recycled such that the aqueous solution comprises at least a portion of the foamate.

8. The method of claim 7, wherein the aqueous solution comprises at least a portion of the foamate and a second amount of surfactant.

9. The method of claim 1, wherein the foamate is recycled in a batch manner, such that the aqueous solution comprises at least a portion of the foamate and a second dose of surfactant.

10. A foam fractionation system, comprising:
a vessel comprising:
a vessel body portion comprising an interior volume configured to process an input liquid solution; and
an elongated portion in fluid communication with the interior volume; and
a bubbler configured to:
receive a gas input, and
inject bubbles into the interior volume;
wherein:
at least 80% of the total volume of the bubbles is made up of bubbles having a largest cross-sectional dimension of greater than or equal to 1 micron and less than or equal to 200 microns; and
the elongated portion has:
a flowpath length along a long axis along a direction of fluid flow from the interior volume; and
an average cross-sectional area along the long axis;
wherein a ratio of the flowpath length divided by the average cross-sectional area is greater than or equal to 1 cm/cm².

11. A foam fractionation system, comprising:
a vessel comprising:
a vessel body portion comprising an interior volume configured to process an input liquid solution; and
an elongated portion in fluid communication with the interior volume; and
a bubbler configured to:
receive a gas input, and
inject bubbles into the interior volume;
wherein:
at least 80% of the total volume of the bubbles is made up of bubbles having a largest cross-sectional dimension of greater than or equal to 1 micron and less than or equal to 200 microns;
the elongated portion has an average cross-sectional area perpendicular to a direction of fluid flow from the interior volume; and
a ratio of the volume of the interior volume divided by the average cross-sectional area of the elongated portion is greater than or equal to 2000 cm.

12. A foam fractionation system, comprising:
a vessel comprising:
a vessel body portion comprising an interior volume configured to process an input liquid solution; and
an elongated portion in fluid communication with the interior volume; and
a bubbler configured to:
receive a gas input, and
inject bubbles into the interior volume;
wherein:
at least 80% of the total volume of the bubbles is made up of bubbles having a largest cross-sectional dimension of greater than or equal to 1 micron and less than or equal to 200 microns; and
the vessel body portion comprises a main body portion and a taper portion, wherein the main body portion is connected to the elongated portion via the taper portion.

13. The foam fractionation system of claim 10, wherein the elongated portion comprises a foamate output at a distal end of the elongated portion with respect to the interior volume, the foamate output in fluid communication with the interior volume.

14.-18. (canceled)

19. The foam fractionation system of claim 10, wherein the elongated portion has an average cross-sectional area perpendicular to a direction of fluid flow that is less than or equal to 20 cm².

20. The foam fractionation system of claim 12, wherein the vessel comprises a main body portion and a taper portion, wherein the main body portion is connected to the elongated portion via the taper portion and comprises a body wall at least partially enclosing the interior volume, wherein the taper portion comprises a taper wall, and wherein an angle established by the body wall and the taper wall facing the interior volume is greater than or equal to 120 degrees and less than or equal to 150 degrees.

21-23. (canceled)

24. The foam fractionation system of claim 10, wherein at least a portion of the bubbler is located within the interior volume such that the bubbles are injected directly into fluid within the interior volume, when present.

25-26. (canceled)

27. The foam fractionation system of claim 10, wherein the foam fractionation system further comprises a foam separation device.

28. The foam fractionation system of claim 10, wherein the liquid solution entry if fluidically connected to a source of surfactant and wherein a ratio between the largest cross-sectional dimension of the bubbles and the effective hydrodynamic radius of the surfactant is less than or equal 10,000 and greater than or equal to 45.

29. (canceled)

30. The foam fractionation system of claim 10, wherein the system is configured such that the input liquid solution comprises at least a portion of a liquid output.

31. The foam fractionation system of claim 13, wherein the system is configured such that the input liquid solution comprises at least a portion of the foamate output.

32. (canceled)

33. The method of claim 1, wherein the method is performed by the foam fractionation system of claim 10.

34. The method of claim 1, wherein the method is performed by two or more foam fractionation systems of claim 10.

35. The method of claim 34, wherein the two or more foam fractionation systems are fluidically connected.
